(19) United States
(12) Patent Application Publication
(10) Pub. No.: US 2026/0085257 A1
(43) Pub. Date: Mar. 26, 2026

(54) LIQUID COMPOSITION

(71) Applicant: The Procter & Gamble Company, Cincinnati, OH (US)

(72) Inventors: Douglas James WILDEMUTH, Cincinnati, OH (US); William Coffin SHEAROUSE, Cincinnati, OH (US); Mark Robert SIVIK, Mason, OH (US); Jana Verena Margarethe HERZBERGER, Florence, KY (US); Kevin Casimir BRUSKIEWITZ, Cincinnati, OH (US)

(21) Appl. No.: 18/890,865

(22) Filed: Sep. 20, 2024

(51) Int. Cl. C11D 1/83; C11D 1/14; C11D 1/22; C11D 1/72; C11D 1/75; C11D 3/20; C11D 3/33; C11D 3/386

(52) U.S. Cl. CPC C11D 1/83; C11D 3/2079; C11D 3/2086; C11D 3/33; C11D 3/38618; C11D 1/146; C11D 1/22; C11D 1/72; C11D 1/75

(57) ABSTRACT

A detergent composition includes from 1 to 50 wt. % of a surfactant system by weight of the composition. The surfactant system includes greater than 30 wt. % nonionic surfactant by weight of the surfactant system, less than 30 wt. % linear alkyl benzene sulfonate surfactant by weight of the surfactant system, and a surfactant selected from the group consisting of sodium lauryl sulfate, highly branched alkyl sulfate, amine oxide, alkyl glycol sulfate, or combinations thereof. The detergent composition further includes at least 0.5 wt. % organic acid by weight of the composition. The composition is substantially free of elemental boron complexes, and the composition has a pH of from 5.4 to 6.7.

### TECHNICAL FIELD

The present disclosure relates generally to liquid compositions with improved enzyme stability.

### BACKGROUND

The discussion of shortcomings and needs existing in the field prior to the present disclosure is in no way an admission that such shortcomings and needs were recognized by those skilled in the art prior to the present disclosure.

Increased regulatory pressures have necessitated the need to provide consumer laundry detergents with stain removal benefits without regulated chemistries due to environmental and health impacts. Conventionally, detergent compositions have been unstable at a pH range of 5.4 to 6.7 without borate. Borate (boric acid salt complexes) are known to be reversible protease inhibitors, which improve enzyme longevity/stability. Borate inhibitors also prevent proteolysis of accompanying enzymes. In addition, borate and its salts provide sufficient buffering stabilization to liquid detergent products. Borate and its salts are problematic because it is prone to cause product instability and crystallization (leading to precipitates or particulates in the formula). Consequently, finding safer ways to formulate consumer products without borate are needed.

The present disclosure provides a detergent composition having stable enzymes without borate, while still providing requisite buffering for manufacturing and long-term product use. Buffering is function of acid/base reaction properties. The more well buffered a formula is, the more reliably we can produce a product at the target pH and have the product stay at that pH throughout the shelf life of the product. An unbuffered product will see large swings in pH throughout product lifetime as a result of common material degradation chemistries that occur in detergent formulations, such as ester hydrolysis, Shiff-base reactions of perfume, and surfactant hydrolysis. The compositions of the present disclosure include citric acid to stabilize enzymes instead of elemental boron complexes. Additionally, to stabilize the enzymes at a pH of 5.4 to 6.7, the compositions of the present disclosure include a surfactant system with at least 30 wt. % nonionic surfactant, by weight of the surfactant system.

### SUMMARY

In one example of the present disclosure, a detergent composition includes from 1 to 50 wt. % of a surfactant system by weight of the composition. The surfactant system includes greater than 30 wt. % nonionic surfactant by weight of the surfactant system, less than 30 wt. % linear alkyl benzene sulfonate surfactant by weight of the surfactant system, and a surfactant selected from the group consisting of sodium lauryl sulfate, highly branched alkyl sulfate, amine oxide, alkyl ethylene glycol sulfate, or combinations thereof. The composition further includes at least 0.5 wt. % citric acid by weight of the composition. The composition includes less than 8 wt. % alcohol ethoxy sulfate surfactant by weight of the composition, the composition is substantially free of elemental boron complexes, and the composition has a pH of from 5.4 to 6.7.

In another example of the present disclosure, a method for treating a stain on a fabric, includes washing the fabric in a wash liquor including a detergent composition. The detergent composition includes from 1 to 50 wt. % of a surfactant system by weight of the composition. The surfactant system includes greater than 30 wt. % nonionic surfactant by weight of the surfactant system, less than 30 wt. % linear alkyl benzene sulfonate surfactant by weight of the surfactant system, and a surfactant selected from the group consisting of sodium lauryl sulfate, highly branched alkyl sulfate, amine oxide, alkyl ethylene glycol sulfate, or combinations thereof. The composition further includes at least 0.5 wt. % citric acid by weight of the composition. The surfactant system is substantially free of alcohol ethoxy sulfate surfactant, the composition is substantially free of elemental boron complexes, and the composition has a pH of from 5.4 to 6.7.

### DETAILED DESCRIPTION

Features and benefits of the present disclosure will become apparent from the following description, which includes examples. Various modifications will be apparent to those skilled in the art from this description. The scope is not intended to be limited to the particular forms disclosed and the present disclosure covers all modifications, equivalents, and alternatives falling within the spirit and scope of the present disclosure as defined by the claims.

As used herein in reference to formula (I), the term “average value of n” refers to the average moles of ethylene oxide, which is the same as the average degree of ethoxylation. The average n may be an integer or a fraction.

As used herein, the articles including “the,” “a” and “an” when used in a claim or in the specification, are understood to mean one or more of what is claimed or described.

As used herein, the terms “include,” “includes” and “including” are meant to be non-limiting.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All cited patents and other documents are, in relevant part, incorporated by reference as if fully restated herein. The citation of any patent or other document is not an admission that the cited patent or other document is prior art with respect to the present disclosure.

In this description, all concentrations and ratios are on a weight basis of the detergent composition unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### Surfactant System

The detergent composition may comprise from about 5% to about 75%, or about 5% to about 70%, or about 5% to about 65%, or about 5% to about 55%, or about 5% to about 50%, or about 10% to about 45%, or about 10% to about 40%, by weight of the detergent composition of a surfactant. The surfactant may be anionic, nonionic, amphoteric, zwitterionic, or a combination thereof.

The compositions of the present disclosure may include from 1 to 50 weight percent (wt. %) of a surfactant system by weight of the composition. The surfactant system may include greater than 30 wt. % nonionic surfactant by weight of the surfactant system, less than 30 wt. % linear alkyl benzene sulfonate surfactant by weight of the surfactant system, and a surfactant selected from the group consisting of sodium lauryl sulfate, highly branched alkyl sulfate, amine oxide, alkyl glycol sulfate (such as, as a non-limiting example, alkyl ethylene glycol sulfate), or combinations thereof.

The surfactant system may comprise additional surfactants include anionic surfactants, non-ionic surfactant, cationic surfactants, zwitterionic surfactants and amphoteric surfactants and mixtures thereof. Suitable surfactants may be linear or branched, substituted or un-substituted, and may be derived from petrochemical material or biomaterial. Preferred surfactant systems comprise both anionic and nonionic surfactant, preferably in weight ratios from 90:1 to 1:90. In some instances a weight ratio of anionic to nonionic surfactant of at least 1:1 is preferred. However, a ratio below 10:1 may be preferred. The surfactant system may range from 0.1% to 60%, from 1% to 50%, from 5% to 40%, from 8% to 40%, from 8% to 30%, or from 8% to 25% by weight of the composition.

### Anionic Surfactant

Anionic surfactants may include, for example, alkyl benzene sulfonate, methyl ester sulfonate, alkyl ether carboxylate, alkyl sulfate, alkylalkoxylated sulfate, sodium lauryl sulfate, branched 2-alkyl primary alkyl alcohol sulfate, alkyl sulfate, or a combination thereof. The alkyl benzene sulfonate may comprise a linear alkyl benzene sulfonate.

The surfactant system may include from 1 to 30 wt. %, from 1 to 25 wt. %, from 1 to 20 wt. %, from 1 to 15 wt. %, from 1 to 11 wt. %, from 1 to 10 wt. %, from 1 to 8 wt. %, from 1 to 6 wt. %, from 1 to 4 wt. %, from 1 to 3 wt. %, from 1 to 2 wt. %, from 2 to 30 wt. %, from 2 to 25 wt. %, from 2 to 20 wt. %, from 2 to 15 wt. %, from 2 to 11 wt. %, from 2 to 10 wt. %, from 2 to 8 wt. %, from 2 to 6 wt. %, from 2 to 4 wt. %, from 2 to 3 wt. %, from 3 to 30 wt. %, from 3 to 25 wt. %, from 3 to 20 wt. %, from 3 to 15 wt. %, from 3 to 11 wt. %, from 3 to 10 wt. %, from 3 to 8 wt. %, from 3 to 6 wt. %, from 3 to 4 wt. %, from 4 to 30 wt. %, from 4 to 25 wt. %, from 4 to 20 wt. %, from 4 to 15 wt. %, from 4 to 11 wt. %, from 4 to 10 wt. %, from 4 to 8 wt. %, from 4 to 6 wt. %, from 6 to 30 wt. %, from 6 to 25 wt. %, from 6 to 20 wt. %, from 6 to 15 wt. %, from 6 to 11 wt. %, from 6 to 10 wt. %, from 6 to 8 wt. %, from 8 to 30 wt. %, from 8 to 25 wt. %, from 8 to 20 wt. %, from 8 to 15 wt. %, from 8 to 11 wt. %, from 8 to 10 wt. % linear alkyl benzene sulfonate (LAS) surfactant by weight of the surfactant system, or any values within the foregoing ranges or any ranges created thereby.

Linear alkyl benzene sulfonate, may have a small amount of branched alkyl benzene sulfonate as a byproduct of the manufacturing process, but this will generally be less than about 5%. The linear alkyl benzene sulfonate may be present, for example, at a level of 0.5% to about 30%, by weight of the detergent composition. The linear alkyl benzene sulfonate may be selected from, for example, alkyl benzene sulfonic acids, alkali metal or amine salts of C₁₀ to C₁₆ alkyl benzene sulfonic acids. In alkyl benzene sulfonic acids or alkali metal or amine salts of C₁₀ to C₁₆ alkyl benzene sulfonic acids, the linear alkyl benzene sulfonate surfactant can comprise greater than 50% C₁₂, greater than 60%, greater than 70% C₁₂, more preferably greater than 75%. The linear alkyl benzene sulfonate may comprise a C₁₀-C₁₆ alkyl benzene sulfonate, a C₁-C₁₄ alkyl benzene sulfonate, or a mixture thereof. The alkyl benzene sulfonate may be an amine neutralized alkyl benzene sulfonate, an alkali metal neutralized alkyl benzene sulfonate, or a mixture thereof. The amine comprises, for example, monoethanolamine, triethanolamine, monoisopropanolamine, or a mixture thereof. The alkali or alkali earth metal comprises, for example, sodium, potassium, magnesium, or a mixture thereof.

Another acceptable anionic surfactant comprises an alkyl sulfate anionic surfactant. The alkyl sulfate anionic surfactant may include, for example, alkyl sulfate, an alkoxylated alkyl sulfate, or a mixture thereof. The alkyl sulfate anionic surfactant may be a primary or a secondary alkyl sulfate anionic surfactant, or a mixture thereof, for example sodium lauryl sulfate. The alkoxylated alkyl sulfate may comprise an ethoxylated alkyl sulfate, propoxylated alkyl sulfate, a mixed ethoxylated/propoxylated alkyl sulfate, or a mixture thereof. An ethoxylated alkyl sulfate may have an average degree of ethoxylation of between 0.1 to 5, or between 0.5 and 3. The ethoxylated alkyl sulfate may have an average alkyl chain length of between 8 and 18, more preferably between 10 and 16, most preferably between 12 and 15. The alkyl portion of the ethoxylated alkyl sulfate may include, on average, from 13.7 to about 16 or from 13.9 to 14.6 carbons atoms. At least about 50% or at least about 60% of the AES molecule may include having an alkyl portion having 14 or more carbon atoms, from 14 to 18, or from 14 to 17, or from 14 to 16, or from 14 to 15 carbon atoms. The surfactant system may be substantially free of alcohol ethoxy sulfate (AES) surfactant since 1,4-dioxane is an undesirable byproduct of making alcohol ethoxy sulfate (AES). The surfactant system may include from 0 to 15 wt. %, from 0 to 11 wt. %, from 0 to 10 wt. %, from 0 to 8 wt. %, from 0 to 6 wt. %, from 0 to 4 wt. %, from 0 to 3 wt. %, from 0 to 2 wt. %, from 1 to 15 wt. %, from 1 to 11 wt. %, from 1 to 10 wt. %, from 1 to 8 wt. %, from 1 to 6 wt. %, from 1 to 4 wt. %, from 1 to 3 wt. %, from 1 to 2 wt. %, from 2 to 15 wt. %, from 2 to 11 wt. %, from 2 to 10 wt. %, from 2 to 8 wt. %, from 2 to 6 wt. %, from 2 to 4 wt. %, from 2 to 3 wt. %, from 3 to 15 wt. %, from 3 to 11 wt. %, from 3 to 10 wt. %, from 3 to 8 wt. %, from 3 to 6 wt. %, from 3 to 4 wt. %, from 4 to 15 wt. %, from 4 to 11 wt. %, from 4 to 10 wt. %, from 4 to 8 wt. %, from 4 to 6 wt. %, from 6 to 15 wt. %, from 6 to 11 wt. %, from 6 to 10 wt. %, from 6 to 8 wt. %, from 8 to 15 wt. %, from 8 to 11 wt. %, from 8 to 10 wt. % alcohol ethoxy sulfate (AES) surfactant by weight of the surfactant system, or any values within the foregoing ranges or any ranges created thereby. The surfactant system may include less than 50 wt. %, less than 30 wt. %, less than 20 wt. %, less than 15 wt. %, less than 10 wt. %, less than 8 wt. %, less than 5 wt. %, or less than 2 wt. % alcohol ethoxy sulfate (AES) surfactant by weight of the surfactant system.

The composition may be substantially free of alcohol ethoxy sulfate (AES) surfactant. The composition may include less than 8 wt. %, less than 5 wt. %, less than 3 wt. %, less than 2 wt. %, or less than 1.5 wt. % alcohol ethoxy sulfate (AES) surfactant by weight of the composition. The composition may include from 0 to 15 wt. %, from 0 to 11 wt. %, from 0 to 10 wt. %, from 0 to 8 wt. %, from 0 to 6 wt. %, from 0 to 4 wt. %, from 0 to 3 wt. %, from 0 to 2 wt. %, from 0 to 1.5 wt. %, from 0 to 1 wt. %, from 0.5 to 15 wt. %, from 0.5 to 11 wt. %, from 0.5 to 10 wt. %, from 0.5 to 8 wt. %, from 0.5 to 6 wt. %, from 0.5 to 4 wt. %, from 0.5 to 3 wt. %, from 0.5 to 2 wt. %, from 0.5 to 1.5 wt. %, from 0.5 to 1 wt. %, from 1 to 15 wt. %, from 1 to 11 wt. %, from 1 to 10 wt. %, from 1 to 8 wt. %, from 1 to 6 wt. %, from 1 to 4 wt. %, from 1 to 3 wt. %, from 1 to 2 wt. %, from 2 to 15 wt. %, from 2 to 11 wt. %, from 2 to 10 wt. %, from 2 to 8 wt. %, from 2 to 6 wt. %, from 2 to 4 wt. %, from 2 to 3 wt. %, from 3 to 15 wt. %, from 3 to 11 wt. %, from 3 to 10 wt. %, from 3 to 8 wt. %, from 3 to 6 wt. %, from 3 to 4 wt. %, from 4 to 15 wt. %, from 4 to 11 wt. %, from 4 to 10 wt. %, from 4 to 8 wt. %, from 4 to 6 wt. %, from 6 to 15 wt. %, from 6 to 11 wt. %, from 6 to 10 wt. %, from 6 to 8 wt. %, from 8 to 15 wt. %, from 8 to 11 wt. %, from 8 to 10 wt. % alcohol ethoxy sulfate (AES) surfactant by weight of the composition, or any values within the foregoing ranges or any ranges created thereby.

The alkyl ether carboxylate may be linear or branched. It may have an average carbon chain length of about 10 to about 26, about 10 to about 20, or about 16 to about 18. The alkyl ether carboxylate may have an average level of ethoxylation of about 2 to about 20, about 7 to about 13, about 8 to about 12, or about 9.5 to about 10.5. The acid form or salt form may be used. The alkyl chain may contain one cis or trans double bond. Commercial alkyl ether carboxylates are available, for example, from Kao (Akypo®), Huntsman (Empicol®), and Clariant (Emulsogen®).

The alkyl chain of the alkyl sulfate anionic surfactant may be linear, branched or a mixture thereof. A branched alkyl sulfate anionic surfactant may be a branched primary alkyl sulfate, a branched secondary alkyl sulfate, or a mixture thereof, preferably a branched primary alkyl sulfate, wherein the branching preferably is in the 2-position, or alternatively might be present further down the alkyl chain or could be multi-branched with branches spread over the alkyl chain. The weight average degree of branching of alkyl sulfate anionic surfactant may be from 0% to 100% preferably from 0% to 95%, more preferably from 0% to 60%, most preferably from 0% to 20%. Alternatively, the weight average degree of branching of alkyl sulfate anionic surfactant may be from 70% to 100%, preferably from 80% to 90%. Preferably, the alkyl chain is selected from naturally derived material, synthetically derived material, or a mixture thereof. Preferably, the synthetically derived material comprises oxo-synthesized material, Ziegler-synthesized material, Guerbet-synthesized material, Fischer-Tropsch-synthesized material, iso-alkyl synthesized material, or mixtures thereof, preferably oxo-synthesized material.

Branched 2-alkyl primary alkyl alcohol sulfates and 2-alkyl primary alkyl alcohol ethoxy sulfates having specific alkyl chain length distributions, may provide increased stain removal (particularly in cold water). 2-alkyl branched alcohols (and the 2-alkyl branched alkyl sulfates and 2-alkyl branched alkyl ethoxy sulfates and other surfactants derived from them) are positional isomers, where the location of the hydroxymethyl group (consisting of a methylene bridge (—CH₂— unit) connected to a hydroxy (—OH) group) on the carbon chain varies. Thus, a 2-alkyl branched alkyl alcohol is generally composed of a mixture of positional isomers. Furthermore, it is well known that fatty alcohols, such as 2-alkyl branched alcohols, and surfactants are characterized by chain length distributions. In other words, fatty alcohols and surfactants are generally made up of a blend of molecules having different alkyl chain lengths (though it is possible to obtain single chain-length cuts). Notably, the 2-alkyl primary alcohols described herein, which may have specific alkyl chain length distributions and/or specific fractions of certain positional isomers, cannot be obtained by simply blending commercially available materials. Specifically, the distribution of from about 50% to about 100% by weight surfactants having m+n=11 is not achievable by blending commercially available materials.

The detergent composition may comprise a mixture of surfactant isomers of Formula 14 and surfactants of Formula 15:

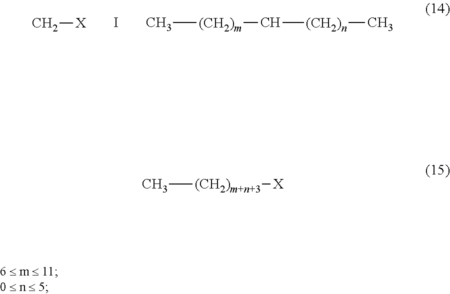

wherein from about 50% to about 100% by weight of the first surfactant are isomers having m+n=11; wherein from about 25% to about 50% of the mixture of surfactant isomers of Formula 14 have n=0; wherein from about 0.001% to about 25% by weight of the first surfactant are surfactants of Formula 15; and wherein X is a hydrophilic moiety.

X may be, for example, neutralized with sodium hydroxide, potassium hydroxide, magnesium hydroxide, lithium hydroxide, calcium hydroxide, ammonium hydroxide, monoethanolamine, diethanolamine, triethanolamine, monoisopropanolamine, diamine, polyamine, primary amine, secondary amine, tertiary amine, amine containing surfactant, or a combination thereof.

X may be selected from sulfates, alkoxylated alkyl sulfates, sulfonates, amine oxides, polyalkoxylates, polyhydroxy moieties, phosphate esters, glycerol sulfonates, polygluconates, polyphosphate esters, phosphonates, sulfosuccinates, sulfosuccaminates, polyalkoxylated carboxylates, glucamides, taurinates, sarcosinates, glycinates, isethionates, dialkanolamides, monoalkanolamides, monoalkanolamide sulfates, diglycolamides, diglycolamide sulfates, glycerol esters, glycerol ester sulfates, glycerol ethers, glycerol ether sulfates, polyglycerol ethers, polyglycerol ether sorbitan sulfates, esters, polyalkoxylated sorbitan esters, ammonioalkanesulfonates, amidopropyl betaines, alkylated quats, alkyated/polyhydroxyalkylated quats, alkylated/polyhydroxylated oxypropyl quats, imidazolines, 2-yl-succinates, sulfonated alkyl esters, sulfonated fatty acids, and mixtures thereof.

The anionic surfactant may also be a biosurfactant. Anionic biosurfactants may include, the class of glycolipids, such as sophorolipids and rhamnolipids and amino acid-based surfactants, e.g., acyl glycinates, acyl sarcosinates, acyl glutamates, and acyl taurates. The rhamnolipids may have a single rhamnose sugar ring or two rhamnose sugar rings.

### Non-Ionic Surfactant

The detergent composition may also comprise a non-ionic surfactant. The surfactant system may include greater than 30 wt. %, or greater than 50 wt. % nonionic surfactant by weight of the surfactant system. The surfactant system may include from 30% to 80%, from 30% to 70%, from 30% to 60%, from 30% to 50%, from 30% to 40%, from 40% to 80%, from 40% to 70%, from 40% to 60%, from 40% to 50%, from 50% to 80%, from 50% to 70%, from 50% to 60%, from 60% to 80%, from 60% to 70%, or from 70% to 80% nonionic surfactant by weight of the surfactant system.

A nonionic surfactant may comprise an alcohol alkoxylate, an oxo-synthesized alcohol alkoxylate, a Guerbet alcohol alkoxylate, an alkyl phenol alcohol alkoxylate, an alkylpolyglucoside, or a mixture thereof. Preferably, a non-ionic surfactant may include, for example, alkoxylated alcohol nonionic surfactants, alkyl polyglucoside nonionic surfactants, and mixtures thereof. Preferably, the alkoxylated alcohol non-ionic surfactant is a linear or branched, primary or secondary alkyl alkoxylated non-ionic surfactant, preferably an alkyl alkoxylated non-ionic surfactant, preferably an alkyl ethoxylated non-ionic surfactant, preferably comprising on average from about 9 to about 15, preferably from about 10 to about 16, more preferably from about 12 to about 15, carbon atoms in its alkyl chain; and on average from about 5 to about 12, preferably from about 6 to about 10, most preferably from about 7 to about 8 or from about 9 to about 10, units of ethylene oxide per mole of alcohol. For example, a non-ionic surfactant can comprises an ethoxylated non-ionic surfactant wherein the ethoxylated nonionic surfactant with an average carbon chain length of about 10 to about 16 comprises an ethoxylated nonionic surfactant with an average carbon chain length of about 12 to about 14 and an average level of ethoxylation of about 9 and a second ethoxylated nonionic surfactant with an average carbon chain length of about 14 to about 15 and an average ethoxylation of about 7.

The nonionic surfactant may have the formula R(OC₂H₄)ₙOH, wherein R is selected from the group consisting of aliphatic hydrocarbon radicals containing from about 8 to about 16 carbon atoms and can be linear or branched and the average value of n is from about 5 to about 15. For example, the additional nonionic surfactant may be selected from ethoxylated alcohols having an average of about 12-14 carbon atoms in the alcohol (alkyl) portion and an average degree of ethoxylation of about 7-9 moles of ethylene oxide per mole of alcohol.

Additional non limiting examples include ethoxylated alkyl phenols of the formula R(OC₂H₄)ₙOH, wherein R comprises an alkyl phenyl radicals in which the alkyl groups contain from about 8 to about 12 carbon atoms, and the average value of n is from about 5 to about 15, C₁₂-C₁₈ alkyl ethoxylates, such as, NEODOL® nonionic surfactants from Shell; C₁₄-C₂₂ mid-chain branched alcohols; C₁₄-C₂₂ mid-chain branched alkyl ethoxylates, BAEₓ, wherein x is from 1 to 30.

The nonionic ethoxylated alcohol surfactant herein may further comprise residual alkoxylation catalyst, which may be considered residue from the reaction or an impurity. It may further comprise various impurities or by-products of the alkoxylation reaction. The impurities may vary depending on the catalyst used and the conditions of the reaction. Impurities include alkyl ethers, e.g., dialkyl ethers, such as, didodecyl ether, glycols, e.g., diethylene glycol, triethylene glycol, pentaethylene glycol, other polyethylene glycols.

The nonionic ethoxylated alcohol may be a narrow range ethoxylated alcohol. A narrow range ethoxylated alcohol may have the following general formula (I):

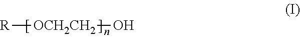

where R is selected from a saturated or unsaturated, linear or branched, C₁₀-C₁₆ alkyl group and where greater than 90% of n is 0≤n≤15. In addition, the average value of n can be between about 4 to about 14, preferably about 6 to about 10, where less than about 10% by weight of the alcohol ethoxylate are ethoxylates having n<7 and between 10% and about 20% by weight of the alcohol ethoxylate are ethoxylates having n=8.

The composition may comprise an average value of n of about 10. The composition may have the following ranges for each of the following n: n=0 of up to 5%, each of n=1, 2, 3, 4, 5 of up to 2%, n=6 of up to 4%, n=7 of up to 10%, n=8 of between 12% and 20%, n=9 of between 15% and 25%, n=10 of between 15% to 30%, n=11 of between 10% and 20%, n=12 of up to 10%, and n>12 at up to 10%. The composition may have n=9 to 10 of between 30% and 70%. The composition may have greater than 50% of its composition made up of n=8 to 11.

R can be selected from a saturated or unsaturated, linear or branched, C₁₀-C₁₆ alkyl group, where the average value of n is between about 6 and about 10. R can also be selected from a saturated or unsaturated, linear or branched, C₈-C₁₆ alkyl group, where greater than 90% of n is 0≤n≤15, and where the average value of n between about 5 to about 10, where less than about 20% by weight of the alcohol ethoxylate are ethoxylates having n<8. R can also be selected from a saturated or unsaturated, linear or branched, C₁₀-C₁₆ alkyl group, where greater than 90% of n is 0≤n≤15, and where the average value of n between about 6 to about 10, where less than about 10% by weight of the alcohol ethoxylate are ethoxylates having n<7 and between 10% and about 20% by weight of the alcohol ethoxylate are ethoxylates having n=8.

The alcohol ethoxylates described herein are typically not single compounds as suggested by their general formula (I), but rather, they comprise a mixture of several homologs having varied polyalkylene oxide chain length and molecular weight. Among the homologs, those with the number of total alkylene oxide units per mole of alcohol closer to the most prevalent alkylene oxide adduct are desirable; homologs whose number of total alkylene oxide units is much lower or much higher than the most prevalent alkylene oxide adduct are less desirable. In other words, a “narrow range” or “peaked” alkoxylated alcohol composition is desirable. A “narrow range” or “peaked” alkoxylated alcohol composition refers to an alkoxylated alcohol composition having a narrow distribution of alkylene oxide addition moles.

A “narrow range” or “peaked” alkoxylated alcohol composition may be desirable for a selected application. Homologs in the selected target distribution range may have the proper lipophilic-hydrophilic balance for a selected application. For example, in the case of an ethoxylated alcohol product comprising an average ratio of 5 ethylene oxide (EO) units per molecule, homologs having a desired lipophilic-hydrophilic balance may range from 2EO to 9EO. Homologs with shorter EO chain length (<2EO) or longer EO chain length (>9EO) may not be desirable for the applications for which a=5 EO/alcohol ratio surfactant is ordinarily selected since such longer and shorter homologs are either too lipophilic or too hydrophilic for the applications utilizing this product. Therefore, it is advantageous to develop an alkoxylated alcohol having a peaked distribution.

The narrow range alkoxylated alcohol compositions of the disclosure may have an average degree of ethoxylation ranging from about 0 to about 15, such as, for example, ranging from about 4 to about 14, from about 5-10, from about 8-11, and from about 6-9. The narrow range alkoxylated alcohol compositions of the disclosure may have an average degree of ethoxylation of 10. The narrow range alkoxylated alcohol compositions of the disclosure may have an average degree of ethoxylation of 9. The narrow range alkoxylated alcohol compositions of the disclosure may have an average degree of ethoxylation of 5.

The alkyl polyglucoside surfactant can be selected from C₁₀-C₁₆ alkyl polyglucoside surfactant. The alkyl polyglucoside surfactant can have a number average degree of polymerization of from 0.1 to 3.0, preferably from 1.0 to 2.0, more preferably from 1.2 to 1.6. The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C₈-C₁₀, mid to long chain alkyl polyglucoside surfactants have a monomodal chain length distribution between C₁₀-C₁₈, while mid chain alkyl polyglucoside surfactants have a monomodal chain length distribution between C₁₂-C₁₄. In contrast, C₈ to C₁₈ alkyl polyglucoside surfactants typically have a monomodal distribution of alkyl chains between C₈ and C₁₈, as with C₈ to C₁₆ and the like. As such, a combination of short chain alkyl polyglucoside surfactants with mid to long chain or mid chain alkyl polyglucoside surfactants have a broader distribution of chain lengths, or even a bimodal distribution, than non-blended C₈ to C₁₈ alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

C₁₀-C₁₆ alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

### Cationic Surfactant

Suitable cationic surfactants include alkyl pyridinium compounds, alkyl quaternary ammonium compounds, alkyl quaternary phosphonium compounds, alkyl ternary sulfonium compounds, and mixtures thereof.

Preferred cationic surfactants are quaternary ammonium compounds having the general formula:

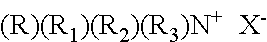

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulfate; and sulfonate.

The fabric care compositions of the present disclosure may contain up to about 30%, alternatively from about 0.01% to about 20%, more alternatively from about 0.1% to about 20%, by weight of the composition, of a cationic surfactant. For the purposes of the present disclosure, cationic surfactants include those which can deliver fabric care benefits. Non-limiting examples of useful cationic surfactants include: fatty amines, imidazoline quat materials and quaternary ammonium surfactants, preferably N, N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl)N-(2 hydroxyethyl)N-methyl ammonium methyl sulfate; 1,2 di (stearoyl-oxy) 3 trimethyl ammonium propane chloride dialkylene dimethyl ammonium salts such as dicanoladimethylammonium chloride, di(hard)tallow dimethyl ammonium chloride dicanoladimethylammonium methyl sulfate; 1-methyl-1-stearoylamidoethyl-2-stearoylimidazolinium methyl sulfate; 1-tallowylamidoethyl-2-tallowylimidazoline; N,N″-dialkyl diethylenetriamine; the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid; polyglycerol esters (PGEs), oily sugar derivatives, and wax emulsions and a mixture of the above.

It will be understood that combinations of softener actives disclosed above are suitable for use herein.

### Amphoteric and Zwitterionic Surfactant

Suitable amphoteric or zwitterionic surfactants include amine oxides, and/or betaines. Preferred amine oxides are alkyl dimethyl amine oxide or alkyl amidopropyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3)O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides.

It has been surprisingly found that one can reap the grease cleaning benefits of amine oxide while controlling the level of suds in the wash cycle without the use of silicone suds suppressors. As shown in Tables 1-5, it has been surprisingly found that by utilizing selective ratios of Fatty Acid (FA) to Amine Oxide (AO), one can create a cleaning composition that exhibits ‘best in class’ cleaning performance, cycle times, and water usage without the use of AES surfactants and silicone suds suppressors.

Other suitable surfactants include betaines, such as alkyl betaines, alkylamidobetaine, amidazoliniumbetaine, sulfobetaine (sultaines) as well as phosphobetaines.

### Shading Dye

Fabric shading can be accomplished through application of any suitable ingredient as known in the art. Preferred fabric shading agents include fabric shading dyes, leuco dyes, pigments and mixtures thereof.

Fabric shading leading in some cases to whiteness improvements can be accomplished through application of leuco dyes via use of a single compound or a leuco composition comprising at least one leuco compound comprising any suitable leuco moiety. In one aspect, the leuco moiety is selected from the group consisting diarylmethane leuco moieties, triarylmethane leuco moieties, oxazine moieties, thiazine moieties, hydroquinone moieties, and arylaminophenol moieties. The leuco compound may comprise a leuco moiety and an alkyleneoxy moiety covalently bound to the leuco moiety, wherein the alkyleneoxy moiety comprises at least one ethylene oxide group, preferably the alkylene oxide moiety also comprises at least one propylene oxide group. In one aspect, preferred leuco compounds include those conforming to the structure of Formula (CVIII),

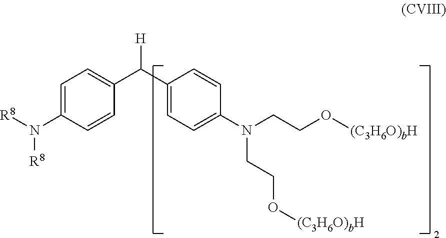

wherein R⁸ is H or CH₃ and each index b is independently on average about 1 to 2. Other suitable leuco dyes are disclosed in U.S. Pat. Nos. 10,377,976, 10,377,977, 10,351,709, 10,385,294, 10,472,595, 10,479,961, 10,501,633, 10,577,570, 10,590,275, 10,633,618, 10,647,854, and 10,676,699, incorporated in their entirety herein by reference.

The composition may comprise an additional fabric shading agent. Suitable fabric shading agents include dyes, dye-clay conjugates, and pigments. Suitable dyes include small molecule dyes and polymeric dyes. Suitable small molecule dyes include small molecule dyes selected from the group consisting of dyes falling into the Color Index (C.I.) classifications of Direct Blue, Direct Red, Direct Violet, Acid Blue, Acid Red, Acid Violet, Basic Blue, Basic Violet and Basic Red, or mixtures thereof. Preferred dyes include alkoxylated azothiophenes, Solvent Violet 13, Acid Violet 50 and Direct Violet 9.

### Encapsulates

The composition may comprise an encapsulated material. In one aspect, an encapsulate comprising a core, a shell having an inner and outer surface, said shell encapsulating said core. The core may comprise any laundry care adjunct, though typically the core may comprise material selected from the group consisting of perfumes; brighteners; hueing dyes; insect repellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polyvinyl alcohols, optionally containing other co-monomers; polystyrenes; polyisoprenes; polycarbonates; polyesters; polyacrylates; aminoplasts, in one aspect said aminoplasts may comprise a polyurea, polyurethane, and/or polyurea urethane, in one aspect said polyurea may comprise polyoxymethylene urea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

Suitable capsules that can be made by following the teaching of USPA 2008/0305982 A1; and/or USPA 2009/0247449 A1. Alternatively, suitable capsules can be purchased from Appleton Papers Inc. of Appleton, Wisconsin USA.

### Perfume

The compositions of the present disclosure may comprise perfume. Typically, the composition comprises a perfume that comprises one or more perfume raw materials, selected from the group as described in WO08/87497. However, any perfume useful in a laundry care composition may be used.

### Polymers

The composition may comprise one or more polymers. Examples are optionally modified carboxymethylcellulose, modified polyglucans, poly(vinyl-pyrrolidone), poly(ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

The composition may comprise one or more amphiphilic cleaning polymers. Such polymers have balanced hydrophilic and hydrophobic properties such that they remove grease particles from fabrics and surfaces.

### Zwitterionic Polyamine

The composition may comprise a zwitterionic polyamine that is a modified hexamethylenediamine. The modification of the hexamethylenediamine includes: (1) one or two alkoxylation modifications per nitrogen atom of the hexamethylenediamine. The alkoxylation modification consisting of the replacement of a hydrogen atom on the nitrogen of the hexamethylenediamine by a (poly)alkoxylene chain having an average of about 1 to about 40 alkoxy moieties per modification, wherein the terminal alkoxy moiety of the alkoxylene chain is capped with hydrogen, a C1-C4 alkyl, sulfates, carbonates, or mixtures thereof; (2) a substitution of one C1-C4 alkyl moiety and one or two alkoxylation modifications per nitrogen atom of the hexamethylenediamine. The alkoxylation modification consisting of the replacement of a hydrogen atom by a (poly)alkoxylene chain having an average of about 1 to about 40 alkoxy moieties per modification wherein the terminal alkoxy moiety of the alkoxylene chain is capped with hydrogen, a C1-C4 alkyl or mixtures thereof; or (3) a combination thereof

### Graft Polymers Based on Polyalkylene Oxide

The composition may comprise graft polymers which comprising polyalkylene oxide backbone (A) as a graft base and polymeric sidechains (B) grafted thereon. The polymeric sidechains (B) are obtainable by polymerization of at least one vinyl ester monomer. The polyalkylene oxide backbone (A) is obtainable by polymerization of at least one monomers selected from the group of ethylene oxide, 1,2-propylene oxide, 1,2-butylene oxide, 2,3-butylene oxide, 1,2-pentene oxide or 2,3-pentene oxide. Such graft polymers are known as effective soil suspension polymers for hydrophobic and hydrophilic stains, surfactant boosters, and sometimes as dye transfer inhibitors. Suitable graft polymers include amphiphilic graft co-polymer comprises polyethylene glycol backbone (A) as a graft base, and at least one pendant sidechains (B) selected from polyvinyl acetate, polyvinyl alcohol and mixtures thereof. A preferred graft polymer of this type is Sokalan HP22 available from BASF.

Suitable graft polymers are also described in WO2007/138053 as amphiphilic graft polymers based on water-soluble polyalkylene oxides (A) as a graft base and side chains formed by polymerization of a vinyl ester component (B), said polymers having an average of <one graft site per 50 alkylene oxide units and mean molar masses M of from 3 000 to 100 000. One specific preferred graft polymer of this type is polyvinyl acetate grafted polyethylene oxide copolymer having a polyethylene oxide as graft base and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units. The most preferred polymer of this type is available from BASF as Sokalan PG101.

Suitable graft polymer also include graft polymer comprising a block copolymer backbone (A) as a graft base, wherein said block copolymer backbone (A) is obtainable by polymerization of at least two monomers selected from the group of ethylene oxide, 1,2-propylene oxide, 1,2-butylene oxide, 2,3-butylene oxide, 1,2-pentene oxide or 2,3-pentene oxide, wherein the number (x) of individual blocks within the block copolymer backbone (A) is an integer, wherein x is from 2 to 10 and preferably 3 to 5, and (B) polymeric sidechains grafted onto the block copolymer backbone, wherein said polymeric sidechains (B) are obtainable by polymerization of at least one vinyl ester monomer. Suitable graft polymers of this type are described in WO2021/160795 and WO2021/160851, these polymers have improved biodegradation profiles.

Suitable graft polymer also include graft polymer comprising a polyalkylene oxide backbone (A) which has a number average molecular weight of from about 1000 to about 20,000 Daltons and is based on ethylene oxide, propylene oxide, or butylene oxide; and side chains derived from N-vinylpyrrolidone (B), and side chains derived from vinyl ester (C) derived from a saturated monocarboxylic acid containing from 1 to 6 carbon atoms and/or a methyl or ethyl ester of acrylic or methacrylic acid. Such graft polymers are described in WO2020005476 and can be used as dye transfer inhibitors.

### Soil Release Polymers

The composition may comprise one or more soil release polymers. Examples include soil release polymers having a structure as defined by one of the following Formula (VI), (VII) or (VIII):

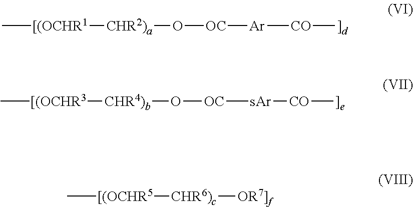

wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Na, Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN260, SRN300 and SRN325 supplied by Clariant. Other suitable soil release polymers are Marloquest polymers, such as Marloquest SL supplied by Sasol. For the purposes of this disclosure, SRP and SRA may be used interchangeably.

Known polymeric soil release agents, hereinafter “SRA” or “SRA's”, can optionally be employed in the present detergent compositions. If utilized, SRA's will generally comprise from 0.01% to 10.0%, typically from 0.1% to 5%, preferably from 0.2% to 3.0% by weight, of the composition. Due to hydrolysis risk, the soil release polymers (SRP's) are typically added into the composition of the present disclosure when the composition has a pH of lower than 9 and within 0.5 pH units of the pH target for the final composition.

SRA's can include, for example, a variety of charged, e.g., anionic or even cationic (see U.S. Pat. No. 4,956,447), as well as noncharged monomer units and structures may be linear, branched or even star-shaped. Examples of SRAs are described in U.S. Pat. Nos. 4,968,451; 4,711,730; 4,721,580; 4,702,857; 4,877,896; 3,959,230; 3,893,929; 4,000,093; 5,415,807; 4,201,824; 4,240,918; 4,525,524; 4,201,824; 4,579,681; and 4,787,989; European Patent Application 0 219 048; 279,134 A; 457,205 A; and DE 2,335,044.

### Carboxylate Polymer

The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Alternatively, these materials may comprise polyacrylates having one ethoxy side-chain per every 7-8 acrylate units. The side-chains are of the formula-(CH₂CH₂O)ₘ(CH₂)ₙCH₃ wherein m is 2-3 and n is 6-12. The side-chains are ester-linked to the polyacrylate “backbone” to provide a “comb” polymer type structure. The molecular weight can vary, but is typically in the range of about 2000 to about 50,000. Such alkoxylated polycarboxylates can comprise from about 0.05% to about 10%, by weight, of the compositions herein.

### Alkoxylated Polyamine-Based Polymers

The composition may comprise alkoxylated polyamines. Such materials include but are not limited to ethoxylated polyethyleneimine, ethoxylated hexamethylene diamine, and sulfated versions thereof. Polypropoxylated derivatives are also included. A wide variety of amines and polyalkyleneimines can be alkoxylated to various degrees, and optionally further modified to provide the abovementioned benefits. A useful example is 600 g/mol polyethyleneimine core ethoxylated to 20 EO groups per NH. A preferred ethoxylated polyethyleneimine is PE-20 available from BASF.

### Cellulosic Polymer

Cellulosic polymers may be used. Suitable cellulosic polymers are selected from alkyl cellulose, alkyl alkoxyalkyl cellulose, carboxyalkyl cellulose, alkyl carboxyalkyl cellulose, sulfoalkyl cellulose, more preferably selected from carboxymethyl cellulose, methyl cellulose, methyl hydroxyethyl cellulose, methyl carboxymethyl cellulose, and mixtures thereof. Suitable carboxymethyl celluloses have a degree of carboxymethyl substitution from 0.5 to 0.9 and a molecular weight from 100,000 Da to 300,000 Da. Suitable carboxymethyl celluloses have a degree of substitution greater than 0.65 and a degree of blockiness greater than 0.45, e.g. as described in WO09/154933.

### Cationic Polymers

Cationic polymers may also be used. Suitable cationic polymers will have cationic charge densities of at least 0.5 meq/gm, in another example at least 0.9 meq/gm, in another example at least 1.2 meq/gm, in yet another example at least 1.5 meq/gm, but in one example also less than 7 meq/gm, and in another example less than 5 meq/gm, at the pH of intended use of the composition, which pH will generally range from pH 3 to pH 9, in one example between pH 4 and pH 8. Herein, “cationic charge density” of a polymer refers to the ratio of the number of positive charges on the polymer to the molecular weight of the polymer. The average molecular weight of such suitable cationic polymers will generally be between 10,000 and 10 million, in one example between 50,000 and 5 million, and in another example between 100,000 and 3 million. Suitable cationic polymers are described in U.S. Pat. Nos. 3,962,418; 3,958,581; and U.S. Publication No. 2007/0207109A1.

### Dye Transfer Inhibitor (DTI)

The composition may comprise one or more dye transfer inhibiting agent. Suitable dye transfer inhibitors include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. Suitable examples include PVP-K15, PVP-K30, ChromaBond S-400, ChromaBond S-403E and Chromabond S-100 from Ashland Aqualon, and Sokalan HP165, Sokalan HP50, Sokalan HP53, Sokalan HP59, Sokalan® HP 56K, Sokalan® HP 66 from BASF. The dye control agent may be selected from (i) a sulfonated phenol/formaldehyde polymer; (ii) a urea derivative; (iii) polymers of ethylenically unsaturated monomers, where the polymers are molecularly imprinted with dye; (iv) fibers consisting of water-insoluble polyamide, wherein the fibers have an average diameter of not more than about 2 μm; (v) a polymer obtainable from polymerizing benzoxazinc monomer compounds; and (vi) combinations thereof. Other suitable DTIs are as described in WO2012/004134. When present in a subject composition, the dye transfer inhibiting agents may be present at levels from about 0.0001% to about 10%, from about 0.01% to about 5% or even from about 0.1% to about 3% by weight of the composition.

### Other Water-Soluble Polymers

Examples of water soluble polymers include but are not limited to polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; cellulose, alkyl cellulosics such as methyl cellulose, ethyl cellulose and propyl cellulose; cellulose ethers; cellulose esters; cellulose amides; polyvinyl acetates; polycarboxylic acids and salts; polyaminoacids or peptides; polyamides; polyacrylamide; copolymers of maleic/acrylic acids; polysaccharides including starch, modified starch; gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth; and combinations thereof.

### Oligoamines

Non-limiting examples of amines include, but are not limited to, etheramines, cyclic amines, polyamines, oligoamines (e.g., triamines, diamines, pentamines, tetraamines), or combinations thereof. The compositions described herein may comprise an amine selected from the group consisting of oligoamines, etheramines, cyclic amines, and combinations thereof. In some aspects, the amine is not an alkanolamine. In some aspects, the amine is not a polyalkylencimine.

Examples of suitable oligoamines include Preferably the composition comprises oligoamines. Suitable oligoamines according to the present disclosure may include diethylenetriamine (DETA), 4-methyl diethylenetriamine (4-MeDETA), dipropylenetriamine (DPTA), 5-methyl dipropylenetriamine (5-MeDPTA), triethylenetetraamine (TETA), 4-methyl triethylenetetraamine (4-MeTETA), 4,7-dimethyl triethylenetetraamine (4,7-Me2TETA), 1,1,4,7,7-pentamethyl diethylenetriamine (M5-DETA), tripropylenetetraamine (TPTA), tetraethylenepentaamine (TEPA), tetrapropylenepentaamine (TPPA), pentaethylenehexaamine (PEHA), pentapropylenehexaamine (PPHA), hexaethylencheptaamine (HEHA), hexapropyleneheptaamine (HPHA), N,N′-Bis(3-aminopropyl)ethylenediamine, 1,1,4,7,7-pentamethyl diethylenetriamine (M5-DETA), dipropylenetriamine (DPTA) or mixtures thereof most preferably diethylenetriamine (DETA). DETA may be preferred due to its low molecular weight and/or relatively low cost to produce.

The oligoamines of the present disclosure may have a molecular weight of between about 100 to about 1200 Da, or from about 100 to about 900 Da, or from about 100 to about 600 Da, or from about 100 to about 400 Da, preferably between about 100 Da and about 250 Da, most preferably between about 100 Da and about 175 Da, or even between about 100 Da and about 150 Da. For purposes of the present disclosure, the molecular weight is determined using the free base form of the oligoamine.

### Etheramines

The cleaning compositions described herein may contain an etheramine. The cleaning compositions may contain from about 0.1% to about 10%, or from about 0.2% to about 5%, or from about 0.5% to about 4%, by weight of the composition, of an etheramine.

The etheramines of the present disclosure may have a weight average molecular weight of less than about grams/mole 1000 grams/mole, or from about 100 to about 800 grams/mole, or from about 200 to about 450 grams/mole, or from about 290 to about 1000 grams/mole, or from about 290 to about 900 grams/mole, or from about 300 to about 700 grams/mole, or from about 300 to about 450 grams/mole. The etheramines of the present disclosure may have a weight average molecular weight of from about 150, or from about 200, or from about 350, or from about 500 grams/mole, to about 1000, or to about 900, or to about 800 grams/mole.

### Enzymes

Preferably the composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in the composition, the aforementioned additional enzymes may be present at levels from about 0.00001% to about 2%, from about 0.0001% to about 1% or even from about 0.001% to about 0.5% enzyme protein by weight of the composition.

The composition may exhibit retained enzyme activity after 2 weeks of aging at 35° C. of from 20% to 100%, from 20% to 95%, from 20% to 90%, from 20% to 85%, from 20% to 80%, from 20% to 75%, from 20% to 70%, from 20% to 65%, from 20% to 60%, from 20% to 55%, from 20% to 50%, from 20% to 45%, from 20% to 40%, from 20% to 30%, from 30% to 100%, from 30% to 95%, from 30% to 90%, from 30% to 85%, from 30% to 80%, from 30% to 75%, from 30% to 70%, from 30% to 65%, from 30% to 60%, from 30% to 55%, from 30% to 50%, from 30% to 45%, from 30% to 40%, from 40% to 100%, from 40% to 95%, from 40% to 90%, from 40% to 85%, from 40% to 80%, from 40% to 75%, from 40% to 70%, from 40% to 65%, from 40% to 60%, from 40% to 55%, from 40% to 50%, from 40% to 45%, from 45% to 100%, from 45% to 95%, from 45% to 90%, from 45% to 85%, from 45% to 80%, from 45% to 75%, from 45% to 70%, from 45% to 65%, from 45% to 60%, from 45% to 55%, from 45% to 50%, from 50% to 100%, from 50% to 95%, from 50% to 90%, from 50% to 85%, from 50% to 80%, from 50% to 75%, from 50% to 70%, from 50% to 65%, from 50% to 60%, from 50% to 55%, from 55% to 100%, from 55% to 95%, from 55% to 90%, from 55% to 85%, from 55% to 80%, from 55% to 75%, from 55% to 70%, from 55% to 65%, from 55% to 60%, from 60% to 100%, from 60% to 95%, from 60% to 90%, from 60% to 85%, from 60% to 80%, from 60% to 75%, from 60% to 70%, from 60% to 65%, from 65% to 100%, from 65% to 95%, from 65% to 90%, from 65% to 85%, from 65% to 80%, from 65% to 75%, from 65% to 70%, from 70% to 100%, from 70% to 95%, from 70% to 90%, from 70% to 85%, from 70% to 80%, from 70% to 75%, from 75% to 100%, from 75% to 95%, from 75% to 90%, from 75% to 85%, from 75% to 80%, from 80% to 100%, from 80% to 95%, from 80% to 90%, from 80% to 85%, from 90% to 100%, from 90% to 95%, from 95% to 100%, or any values within the foregoing ranges or any ranges created thereby.

The composition may exhibit an RA Protease retained enzyme activity after 2 weeks of aging at 35° C. of from 20% to 100%, from 20% to 95%, from 20% to 90%, from 20% to 85%, from 20% to 80%, from 20% to 75%, from 20% to 70%, from 20% to 65%, from 20% to 60%, from 20% to 55%, from 20% to 50%, from 20% to 45%, from 20% to 40%, from 20% to 30%, from 30% to 100%, from 30% to 95%, from 30% to 90%, from 30% to 85%, from 30% to 80%, from 30% to 75%, from 30% to 70%, from 30% to 65%, from 30% to 60%, from 30% to 55%, from 30% to 50%, from 30% to 45%, from 30% to 40%, from 40% to 100%, from 40% to 95%, from 40% to 90%, from 40% to 85%, from 40% to 80%, from 40% to 75%, from 40% to 70%, from 40% to 65%, from 40% to 60%, from 40% to 55%, from 40% to 50%, from 40% to 45%, from 45% to 100%, from 45% to 95%, from 45% to 90%, from 45% to 85%, from 45% to 80%, from 45% to 75%, from 45% to 70%, from 45% to 65%, from 45% to 60%, from 45% to 55%, from 45% to 50%, from 50% to 100%, from 50% to 95%, from 50% to 90%, from 50% to 85%, from 50% to 80%, from 50% to 75%, from 50% to 70%, from 50% to 65%, from 50% to 60%, from 50% to 55%, from 55% to 100%, from 55% to 95%, from 55% to 90%, from 55% to 85%, from 55% to 80%, from 55% to 75%, from 55% to 70%, from 55% to 65%, from 55% to 60%, from 60% to 100%, from 60% to 95%, from 60% to 90%, from 60% to 85%, from 60% to 80%, from 60% to 75%, from 60% to 70%, from 60% to 65%, from 65% to 100%, from 65% to 95%, from 65% to 90%, from 65% to 85%, from 65% to 80%, from 65% to 75%, from 65% to 70%, from 70% to 100%, from 70% to 95%, from 70% to 90%, from 70% to 85%, from 70% to 80%, from 70% to 75%, from 75% to 100%, from 75% to 95%, from 75% to 90%, from 75% to 85%, from 75% to 80%, from 80% to 100%, from 80% to 95%, from 80% to 90%, from 80% to 85%, from 90% to 100%, from 90% to 95%, from 95% to 100%, or any values within the foregoing ranges or any ranges created thereby.

The composition may exhibit an RA Amylase retained enzyme activity after 2 weeks of aging at 35° C. of from 20% to 100%, from 20% to 95%, from 20% to 90%, from 20% to 85%, from 20% to 80%, from 20% to 75%, from 20% to 70%, from 20% to 65%, from 20% to 60%, from 20% to 55%, from 20% to 50%, from 20% to 45%, from 20% to 40%, from 20% to 30%, from 30% to 100%, from 30% to 95%, from 30% to 90%, from 30% to 85%, from 30% to 80%, from 30% to 75%, from 30% to 70%, from 30% to 65%, from 30% to 60%, from 30% to 55%, from 30% to 50%, from 30% to 45%, from 30% to 40%, from 40% to 100%, from 40% to 95%, from 40% to 90%, from 40% to 85%, from 40% to 80%, from 40% to 75%, from 40% to 70%, from 40% to 65%, from 40% to 60%, from 40% to 55%, from 40% to 50%, from 40% to 45%, from 45% to 100%, from 45% to 95%, from 45% to 90%, from 45% to 85%, from 45% to 80%, from 45% to 75%, from 45% to 70%, from 45% to 65%, from 45% to 60%, from 45% to 55%, from 45% to 50%, from 50% to 100%, from 50% to 95%, from 50% to 90%, from 50% to 85%, from 50% to 80%, from 50% to 75%, from 50% to 70%, from 50% to 65%, from 50% to 60%, from 50% to 55%, from 55% to 100%, from 55% to 95%, from 55% to 90%, from 55% to 85%, from 55% to 80%, from 55% to 75%, from 55% to 70%, from 55% to 65%, from 55% to 60%, from 60% to 100%, from 60% to 95%, from 60% to 90%, from 60% to 85%, from 60% to 80%, from 60% to 75%, from 60% to 70%, from 60% to 65%, from 65% to 100%, from 65% to 95%, from 65% to 90%, from 65% to 85%, from 65% to 80%, from 65% to 75%, from 65% to 70%, from 70% to 100%, from 70% to 95%, from 70% to 90%, from 70% to 85%, from 70% to 80%, from 70% to 75%, from 75% to 100%, from 75% to 95%, from 75% to 90%, from 75% to 85%, from 75% to 80%, from 80% to 100%, from 80% to 95%, from 80% to 90%, from 80% to 85%, from 90% to 100%, from 90% to 95%, from 95% to 100%, or any values within the foregoing ranges or any ranges created thereby.

### Builders

Preferably the composition may comprise one or more builders or a builder system. When a builder is used, the composition of the present disclosure will typically comprise at least 1%, from 2% to 60% builder. It may be preferred that the composition comprises low levels of phosphate salt and/or zeolite, for example from 1 to 10 or 5 wt %. The composition may even be substantially free of strong builder; substantially free of strong builder means “no deliberately added” zeolite and/or phosphate. Typical zeolite builders include zeolite A, zeolite P and zeolite MAP. A typical phosphate builder is sodium tri-polyphosphate.

### Organic Acid

The detergent comprises one or more organic acids selected from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, fumaric acid, aspartic acid, malonic acid, oxydiacetic acid, oxydisuccinic acid, succinic acid, sulfamic acid, tartaric acid, tartaric-disuccinic acid, tartaric-monosuccinic acid, or mixtures thereof.

Preferably, the detergent composition may comprise an organic acid selected from the group consisting of acetic acid, lactic acid, and citric acid, most preferably citric acid.

The composition may include at least 0.5 wt. % organic acid by weight of the composition. The composition may include from 0.5 to 10 wt. %, from 0.5 to 5 wt. %, from 0.5 to 4 wt. %, from 0.5 to 3 wt. %, from 0.5 to 2 wt. %, from 0.5 to 1.5 wt. %, from 0.5 to 1 wt. %, from 0.5 to 0.75 wt. %, from 0.75 to 10 wt. %, from 0.75 to 5 wt. %, from 0.75 to 4 wt. %, from 0.75 to 3 wt. %, from 0.75 to 2 wt. %, from 0.75 to 1.5 wt. %, from 0.75 to 1 wt. %, from 1 to 10 wt. %, from 1 to 5 wt. %, from 1 to 4 wt. %, from 1 to 3 wt. %, from 1 to 2 wt. %, from 1 to 1.5 wt. %, from 1.5 to 10 wt. %, from 1.5 to 5 wt. %, from 1.5 to 4 wt. %, from 1.5 to 3 wt. %, from 1.5 to 2 wt. %, from 2 to 10 wt. %, from 2 to 5 wt. %, from 2 to 4 wt. %, or from 2 to 3 wt. % organic acid by weight of the composition or any values within the foregoing ranges or any ranges created thereby.

### Chelating Agent.

Preferably the composition comprises chelating agents and/or crystal growth inhibitor. Suitable molecules include copper, iron and/or manganese chelating agents and mixtures thereof. Suitable molecules include hydroxamic acids, aminocarboxylates, aminophosphonates, succinates, salts thereof, and mixtures thereof. Non-limiting examples of suitable chelants for use herein include ethylenediaminetetracetates, N-(hydroxyethyl)ethylenediaminetriacetates, nitrilotriacetates, ethylenediamine tetraproprionates, triethylenetetraaminchexacetates, diethylenetriamine-pentaacetates, ethanoldiglycines, ethylenediamine-tetrakis (methylenephosphonates), diethylenetriamine penta(methylene phosphonic acid) (DTPMP), ethylenediamine disuccinate (EDDS), hydroxyethanedimethylenephosphonic acid (HEDP), methylglycinediacetic acid (MGDA), diethylenetriaminepentaacetic acid (DTPA), N,N-Dicarboxymethyl glutamic acid (GLDA) and salts thereof, and mixtures thereof. Other nonlimiting examples of chelants of use in the present disclosure are found in U.S. Pat. Nos. 7,445,644, 7,585,376 and 2009/0176684A1. Other suitable chelating agents for use herein are the commercial DEQUEST series, and chelants from Monsanto, DuPont, and Nalco, Inc. Yet other suitable chelants include the pyridinyl N Oxide type.

The composition may include from 0.01 to 2 wt. %, from 0.01 to 1.5 wt. %, from 0.01 to 1.2 wt. %, from 0.01 to 1 wt. %, from 0.01 to 0.7 wt. %, from 0.01 to 0.5 wt. %, from 0.01 to 0.2 wt. %, from 0.01 to 0.05 wt. %, from 0.05 to 2 wt. %, from 0.05 to 1.5 wt. %, from 0.05 to 1.2 wt. %, from 0.05 to 1 wt. %, from 0.05 to 0.7 wt. %, from 0.05 to 0.5 wt. %, from 0.05 to 0.2 wt. %, from 0.2 to 2 wt. %, from 0.2 to 1.5 wt. %, from 0.2 to 1.2 wt. %, from 0.2 to 1 wt. %, from 0.2 to 0.7 wt. %, from 0.2 to 0.5 wt. %, from 0.5 to 2 wt. %, from 0.5 to 1.5 wt. %, from 0.5 to 1.2 wt. %, from 0.5 to 1 wt. %, from 0.5 to 0.7 wt. %, from 0.7 to 2 wt. %, from 0.7 to 1.5 wt. %, from 0.7 to 1.2 wt. %, from 0.7 to 1 wt. %, from 1 to 2 wt. %, from 1 to 1.5 wt. %, from 1 to 1.2 wt. %, from 1.2 to 2 wt. %, from 1.2 to 1.5 wt. %, from 1.5 to 2 wt. %, or any values within the foregoing ranges or any ranges created thereby, of chelating agent, by weight of the composition.

### Fluorescent Brightener:

Commercial fluorescent brighteners suitable for the present disclosure can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

The fluorescent brightener may be selected from the group consisting of disodium 4,4′-bis {[4-anilino-6-morpholino-s-triazin-2-yl]-amino}-2,2′-stilbenedisulfonate (brightener 15, commercially available under the tradename Tinopal AMS-GX by BASF), disodium4,4′-bis {[4-anilino-6-(N-2-bis-hydroxyethyl)-s-triazine-2-yl]-amino}-2,2′-stilbenedisulonate (commercially available under the tradename Tinopal UNPA-GX by BASF), disodium 4,4′-bis {[4-anilino-6-(N-2-hydroxyethyl-N-methylamino)-s-triazine-2-yl]-amino}-2,2′-stilbenedisulfonate (commercially available under the tradename Tinopal 5BM-GX by BASF). More preferably, the fluorescent brightener is disodium 4,4′-bis {[4-anilino-6-morpholino-s-triazin-2-yl]-amino}-2,2′-stilbenedisulfonate or 2,2′-([1,1′-Biphenyl]-4,4′-diyldi-2,1-ethenediyl)bis-benzenesulfonic acid disodium salt. The brighteners may be added in particulate form or as a premix with a suitable solvent, for example nonionic surfactant, propanediol.

The composition may be substantially free of brightener.

### Enzyme Stabilizers.

The composition may preferably comprise enzyme stabilizers. Any conventional enzyme stabilizer may be used, for example by the presence of water-soluble sources of calcium and/or magnesium ions in the finished fabric and home care products that provide such ions to the enzymes. In case of aqueous compositions comprising protease, a reversible protease inhibitor, such as an elemental boron complex including borate, or preferably 4-formyl phenylboronic acid, phenylboronic acid and derivatives thereof, or compounds such as calcium formate, sodium formate and 1,2-propane diol can be added to further improve stability. Sodium formate may also be used as a viscosity modifier. The composition may include less than 2 wt. %, less than 1.5 wt. %, less than 1 wt. %, less than 0.5 wt. %, or less than 0.05 wt. % enzyme stabilizer by weight of the total composition. The composition may include from 0 to 2 wt. %, from 0 to 1.5 wt. %, from 0 to 1 wt. %, from 0 to 0.5 wt. %, from 0.5 to 2 wt. %, from 0.5 to 1.5 wt. %, from 0.5 to 1 wt. %, from 1 to 2 wt. %, from 1 to 1.5 wt. %, or from 1.5 to 2 wt. %. The composition may be substantially free of enzyme stabilizers.

The compositions of the present disclosure may be substantially free of elemental boron complexes. The elemental boron complexes may include sodium tetraborate, boronic acids (such as borate, 4-formyl phenylboronic acid, or phenylboronic acid and derivatives thereof), sodium metaborate, perborate, and combinations thereof.

### Solvents:

The solvent system in the present compositions can be a solvent system containing water alone or mixtures of organic solvents either without or preferably with water. The compositions may optionally comprise an organic solvent. Suitable organic solvents include C₄-14 ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof. Preferred organic solvents include 1,2-propanediol, 2,3 butane diol, ethanol, glycerol, ethoxylated glycerol, dipropylene glycol, methyl propane diol and mixtures thereof 2 ethyl hexanol, 3,5,5, trimethyl-1 hexanol, and 2 propyl heptanol. Solvents may be a polyethylene or polypropylene glycol ether of glycerin. Other lower alcohols, C₁-C₄ alkanolamines such as monoethanolamine and triethanolamine, can also be used. Solvent systems can be absent, for example from anhydrous solid examples of the composition of the present disclosure, but more typically are present at levels in the range of from about 0.1% to about 98%, preferably at least about 1% to about 50%, more usually from about 5% to about 25%, alternatively from about 1% to about 10% by weight of the liquid detergent composition of said organic solvent. These organic solvents may be used in conjunction with water, or they may be used without water.

### Structured Liquids:

In examples, the composition is in the form of a structured liquid. Such structured liquids can either be internally structured, whereby the structure is formed by primary ingredients (e.g. surfactant material) and/or externally structured by providing a three-dimensional matrix structure using secondary ingredients (e.g. polymers, clay and/or silicate material), for use e.g. as thickeners. The composition may comprise a structurant, preferably from 0.01 wt % to 5 wt %, from 0.1 wt % to 2.0 wt % structurant. Examples of suitable structurants are given in US2006/0205631A1, US2005/0203213A1, U.S. Pat. Nos. 7,294,611, 6,855,680. The structurant is typically selected from the group consisting of diglycerides and triglycerides, ethylene glycol distearate, microcrystalline cellulose, cellulose-based materials, microfiber cellulose, hydrophobically modified alkali-swellable emulsions such as Polygel W30 (3VSigma), biopolymers, xanthan gum, gellan gum, hydrogenated castor oil, derivatives of hydrogenated castor oil such as non-ethoxylated derivatives thereof and mixtures thereof, in particular, those selected from the group of hydrogenated castor oil, derivatives of hydrogenated castor oil, microfibullar cellulose, hydroxyfunctional crystalline materials, long chain fatty alcohols, 12-hydroxystearic acids, clays and mixtures thereof. One preferred structurant is described in U.S. Pat. No. 6,855,680 which defines suitable hydroxyfunctional crystalline materials in detail. Preferred is hydrogenated castor oil. Some structurants have a thread-like structuring system having a range of aspect ratios. Another preferred structurant is based on cellulose and may be derived from a number of sources including biomass, wood pulp, citrus fibers and the like.

### Conditioning Agents:

Suitable conditioning agents include high melting point fatty compounds. The high melting point fatty compound useful herein has a melting point of 25° C. or higher and is selected from the group consisting of fatty alcohols, fatty acids, fatty alcohol derivatives, fatty acid derivatives, and mixtures thereof. Preferred fatty acid blends may be mixtures enriched or fatty acid mixtures enriched with 2-alkyl fatty acid, preferably 2-methyl octanoic acid. Suitable conditioning agents also include nonionic polymers and conditioning oils, such as hydrocarbon oils, polyolefins, and fatty esters.

Suitable conditioning agents include those conditioning agents characterized generally as silicones (e.g., silicone oils, polyoils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein. The compositions of the present disclosure may also comprise from about 0.05% to about 3% of at least one organic conditioning oil as the conditioning agent, either alone or in combination with other conditioning agents, such as the silicones (described herein). Suitable conditioning oils include hydrocarbon oils, polyolefins, and fatty esters.

### Probiotics:

The composition may comprise probiotics, such as those described in WO2009/043709.

### Pearlescent Agent:

Non-limiting examples of pearlescent agents include: mica; titanium dioxide coated mica; bismuth oxychloride; fish scales; mono and diesters of alkylene glycol. The pearlescent agent may be ethyleneglycoldistearate (EGDS).

### Opacifier:

In one example, the composition might also comprise an opacifier. As the term is used herein, an “opacifier” is a substance added to a material in order to make the ensuing system opaque. In one preferred example, the opacifier is Acusol, which is available from Dow Chemicals. Acusol opacifiers are provided in liquid form at a certain % solids level. As supplied, the pH of Acusol opacifiers ranges from 2.0 to 5.0 and particle sizes range from 0.17 to 0.45 μm. In one preferred example, Acusol OP303B and 301 can be used.

In yet another example, the opacifier may be an inorganic opacifier. Preferably, the inorganic opacifier can be TiO₂, ZnO, talc, CaCO₃, and combination thereof. The composite opacifier-microsphere material is readily formed with a preselected specific gravity, so that there is little tendency for the material to separate.

### Hydrotrope:

The composition may optionally comprise a hydrotrope in an effective amount, i.e. from about 0% to 15%, or about 1% to 10%, or about 3% to about 6%, so that compositions are compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903.

### Anti-Oxidant:

The composition may optionally contain an anti-oxidant present in the composition from about 0.001 to about 2% by weight. Preferably the antioxidant is present at a concentration in the range 0.01 to 0.08% by weight. Mixtures of anti-oxidants may be used.

Anti-oxidants are substances as described in Kirk-Othmer (Vol. 3, page 424) and In Ullmann's Encyclopedia (Vol. 3, page 91).

One class of anti-oxidants used in the present disclosure is alkylated phenols, having the general formula:

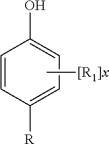

wherein R is C₁-C₂₂ linear or branched alkyl, preferably methyl or branched C₃-C₆ alkyl, C₁-C₆ alkoxy, preferably methoxy; R₁ is a C₃-C₆ branched alkyl, preferably tert-butyl; x is 1 or 2. Hindered phenolic compounds are a preferred type of alkylated phenols having this formula. Examples of such hindered phenol antioxidants may include, but are not limited to: 2,6-bis(1-methylpropyl) phenol; 2,6-bis(1,1-dimethylethyl)-4-methyl-phenol (also known as hydroxy butylated toluene, “BHT”); 2-(1,1-dimethylethyl)-1,4-benzenediol; 2,4-bis(1,1-dimethylethyl)-phenol; 2,6-bis(1,1-dimethylethyl)-phenol; 3,5-bis(1,1-dimethylethyl)-4-hydroxybenzene propanoic acid, methyl ester; 2-(1,1-dimethylethyl)-4-methylphenol; 2-(1,1-dimethylethyl)-4,6-dimethyl-phenol; 3,5-bis(1,1-dimethylethyl)-4-hydroxybenzenepropanoic acid, 1,1′-[2,2-bis[[3-[3,5-bis(1,1-dimethylethyl)-4-hydroxyphenyl]-1-oxopropoxy]methyl]-1,3-propanediyl]ester; 3,5-bis(1,1-dimethylethyl)-4-hydroxybenzenepropanoic acid, octadecyl ester; 2,2′-methylenebis[6-(1,1-dimethylethyl)-4-methylphenol; 2-(1,1-dimethylethyl)-phenol; 2,4,6-tris(1,1-dimethylethyl)-phenol; 4,4′-methylenebis[2,6-bis(1,1-dimethylethyl)-phenol; 4,4′,4″-[(2,4,6-trimethyl-1,3,5-benzenetriyl)tris(methylene)]tris[2,6-bis(1,1-dimethylethyl)-phenol]; N,N′-1,6-hexanediylbis[3,5-bis(1,1-dimethylethyl)-4-hydroxybenzenepropanamide; 3,5-bis(1,1-dimethylethyl)-4-hydroxy benzoic acid, hexadecyl ester; P-[[3,5-bis(1,1-dimethylethyl)-4-hydroxyphenyl]methylphosphonic acid, diethyl ester; 1,3,5-tris[3,5-bis(1,1-dimethylethyl)-4-hydroxyphenyl]methyl]-1,3,5-Triazine-2,4,6 (1H,3H,5H)-trione; 3,5-bis(1,1-5 dimethylethyl)-4-hydroxybenzenepropanoic acid, 2-[3-[3,5-bis(1,1-dimethylethyl)-4-hydroxyphenyl]-1-oxopropyl]hydrazide; 3-(1,1-dimethyl ethyl)-4-hydroxy-5-methylbenzenepropanoic acid, 1,1′-[1,2-ethanediylbis(oxy-2,1-ethanediyl)]ester; 4-[(dimethylamino)methyl]-2,6-bis(1,1-dimethylethyl) phenol; 4-[[4,6-bis(octylthio)-1,3,5-triazin-2-yl]amino]-2,6-bis(1,1-dimethylethyl) phenol; 3,5-bis(1,1-dimethylethyl)-4-hydroxy benzene propanoic acid, 1,1′-(thiodi-2,1-ethanediyl)ester; 3,5-bis(1,1-dimethylethyl)-4-hydroxybenzoic acid, 2,4-bis(1,1-dimethylethyl)phenyl ester; 3,5-bis(1,1-dimethylethyl)-4-hydroxybenzenepropanoic acid, 1,1′-(1,6-hexanediyl)ester; 3-(1,1-dimethylethyl)-4-hydroxy-5-methylbenzenepropanoic acid, 1,1′-[2,4,8,10-tetraoxaspiro[5.5]undecane-3,9-diylbis(2,2-dimethyl-2,1-ethanediyl)]ester; 3-(1,1-dimethylethyl)-b-[3-(1,1-dimethylethyl)-4-hydroxy phenyl]-4-hydroxy-b-methylbenzenepropanoic acid, 1,1′-(1,2-ethanediyl)ester; 2-[[3,5-bis(1,1-dimethylethyl)-4-hydroxyphenyl]methyl]-2-butylpropanedioic acid, 1,3-bis(1,2,2,6,6-pentamethyl-4-piperidinyl)ester; 3,5-bis(1,1-dimethylethyl)-4-hydroxybenzenepropanoic acid, 1-[2-[3-[3,5-bis(1,1-dimethylethyl)-4-hydroxyphenyl]-1-oxopropoxy]ethyl]-2,2,6,6-tetramethyl-4-piperidinyl ester; 3,4-dihydro-2,5,7,8-tetramethyl-2-[(4R,8R)-4,8,12-trimethyltridecyl]-(2R)-2H-1-benzopyran-6-ol; 2,6-dimethylphenol; 2,3,5-trimethyl-1,4-benzenediol; 2,4,6-trimethylphenol; 2,3,6-trimethylphenol; 4,4′-(1-methylethylidene)-bis[2,6-dimethylphenol]; 1,3,5-tris[[4-(1,1-dimethylethyl)-3-hydroxy-2,6-dimethylphenyl]methyl]-1,3,5-triazine-2,4,6(1H,3H,5H)-trione; 4,4′-methylenebis[2,6-dimethylphenol]; and mixtures thereof.

Preferably, the hindered phenol antioxidant comprises at least one phenolic-OH group having at least one C₃-C₆ branched alkyl at a position ortho to said at least one phenolic-OH group. More preferably, the hindered phenol antioxidant is an ester of 3,5-bis(1,1-dimethylethyl)-4-hydroxy-benzenepropanoic acid, and most preferably a C₁-C₂₂ linear alkyl ester of 3,5-bis(1,1-dimethylethyl)-4-hydroxy-benzenepropanoic acid. Commercially available C₁-C₂₂ linear alkyl esters of 3,5-bis(1,1-dimethylethyl)-4-hydroxy-benzenepropanoic acid include RALOX® from Raschig USA (Texas, USA), which is a methyl ester of 3,5-bis(1,1-dimethylethyl)-4-hydroxy-benzenepropanoic acid, and TINOGARD® TS from BASF (Ludwigshafen, Germany), which is an octadecyl ester of 3,5-bis(1,1-dimethylethyl)-4-hydroxy-benzenepropanoic acid.

Furthermore, the anti-oxidant used in the composition may be selected from the group consisting of α-, β-, γ-, δ-tocopherol, ethoxyquin, 2,2,4-trimethyl-1,2-dihydroquinoline, 2,6-di-tert-butyl hydroquinone, tert-butyl hydroxyanisole, lignosulfonic acid and salts thereof, and mixtures thereof. It is noted that ethoxyquin (1,2-dihydro-6-ethoxy-2,2,4-trimethylquinoline) is marketed under the name Raluquin™ by the company Raschig™.

Other types of anti-oxidants that may be used in the composition are 6-hydroxy-2,5,7,8-tetramethylchroman-2-carboxylic acid (Trolox™) and 1,2-benzisothiazoline-3-one (Proxel GXL™).

A further class of anti-oxidants which may be suitable for use in the composition is a benzofuran or benzopyran derivative having the formula:

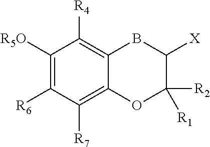

wherein R₁ and R₂ are each independently alkyl or R₁ and R₂ can be taken together to form a C₅-C₆ cyclic hydrocarbyl moiety; B is absent or CH₂; R₄ is C₁-C₆ alkyl; R₅ is hydrogen or —C(O)R₃ wherein R₃ is hydrogen or C₁-C₁₉ alkyl; R₆ is C₁-C₆ alkyl; R₇ is hydrogen or C₁-C₆ alkyl; X is —CH₂OH, or —CH₂A wherein A is a nitrogen comprising unit, phenyl, or substituted phenyl. Preferred nitrogen comprising A units include amino, pyrrolidino, piperidino, morpholino, piperazino, and mixtures thereof. The cleaning compositions of the present disclosure may comprise tannins selected from the group consisting of gallotannins, ellagitannins, complex tannins, condensed tannins, and combinations thereof.

### Preservative:

The formulation may contain a preservative or a mixture of preservatives, selected from benzoic acid and salts thereof, alkylesters of p-hydroxybenzoic acid and salts thereof, preferabenzoic acid and salts thereof, sodium benzoate, methylisothiazolinone and benzisothiazolinone. The preservative is present at 0.01 to 3 wt %, preferably 0.1 to 3 wt %, more preferably 0.3 wt % to 1.5 w %. Weights are calculated for the protonated form.

### Hygiene Agent:

The compositions of the present disclosure may also comprise components to deliver hygiene and/or malodor benefits such as one or more of zinc ricinoleate, thymol, quaternary ammonium salts such as Bardac®, polyethylenimines (such as Lupasol® from BASF) and zinc complexes thereof, silver and silver compounds, especially those designed to slowly release Ag+ or nano-silver dispersions.

The cleaning compositions of the present disclosure may also contain antimicrobial agents. Cationic active ingredients may include but are not limited to n-alkyl dimethyl benzyl ammonium chloride, alkyl dimethyl ethyl benzyl ammonium chloride, dialkyl dimethyl quaternary ammonium compounds such as didecyl dimethyl ammonium chloride, N,N-didecyl-N-methyl-poly(oxyethyl) ammonium propionate, dioctyl didecyl ammonium chloride, also including quaternary species such as benzethonium chloride, alkyl pyridinium chlorides, and quaternary ammonium compounds with inorganic or organic counter ions such as bromine, carbonate or other moieties including dialkyl dimethyl ammonium carbonates, as well as antimicrobial amines such as Chlorhexidine Gluconate, PHMB (Polyhexamethylene biguanide), salt of a biguanide, a substituted biguanide derivative, an organic salt of a quaternary ammonium containing compound or an inorganic salt of a quaternary ammonium containing compound or mixtures thereof. More Preferably, the anti-microbial agent is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan®HP100.

pH

The composition of the present disclosure may have a pH of from 4 to 10, from 5 to 9, from 4 to 8, from 5 to 8, from 5.4 to 6.7, from 5.4 to 6.4, from 5.7 to 6.3, or any values within the foregoing ranges or any ranges created thereby. A pH within this range is beneficial because the pH of the composition of the present disclosure may be controlled using an organic acid (such as, for example, citric acid) as a buffer while also leveraging the organic acid for its in-wash cleaning performance, giving the organic acid multiple functions within the composition of the present disclosure. This is unique because conventionally it has been thought that enzymes would not be stable in a pH range of 5.4 to 6.7, or 5.4 to 6.4, or 5.7 to 6.3 as formulated in the composition of the present disclosure. This is significant as the composition of the present disclosure thereby avoids and does not include undesirable chemistries commonly used to control pH such as, by way of nonlimiting examples, borate and (monoethanolamine) MEA, as well as stabilizing several polymer chemistries such as soil release polymers disclosed above and other ester moieties (such as perfume raw materials or small molecule esters), where the SRP's and other ester moieties are known to degrade at a more common pH of 8-10.

### Viscosity

The composition of the present disclosure may have a low shear viscosity at 0.2 s⁻¹ of from 100 to 20,000 cP, from 100 to 15,000 cP, from 100 to 10,000 cP, from 100 to 5,000 cP, from 100 to 1,000 cP, from 100 to 800 cP, from 100 to 600 cP, from 100 to 400 cP, from 100 to 200 cP, from 200 to 20,000 cP, from 200 to 15,000 cP, from 200 to 10,000 cP, from 200 to 5,000 cP, from 200 to 1,000 cP, from 200 to 800 cP, from 200 to 600 cP, from 200 to 400 cP, from 400 to 20,000 cP, from 400 to 15,000 cP, from 400 to 10,000 cP, from 400 to 5,000 cP, from 400 to 1,000 cP, from 400 to 800 cP, from 400 to 600 cP, from 600 to 20,000 cP, from 600 to 15,000 cP, from 600 to 10,000 cP, from 600 to 5,000 cP, from 600 to 1,000 cP, from 600 to 800 cP, from 600 to 600 cP, from 600 to 400 cP, from 600 to 20,000 cP, from 600 to 15,000 cP, from 600 to 10,000 cP, from 600 to 5,000 cP, from 600 to 1,000 cP, from 600 to 800 cP, from 800 to 20,000 cP, from 800 to 15,000 cP, from 800 to 10,000 cP, from 800 to 5,000 cP, from 800 to 1,000 cP, from 1,000 to 20,000 cP, from 1,000 to 15,000 cP, from 1,000 to 10,000 cP, from 1,000 to 5,000 cP, from 5,000 to 20,000 cP, from 5,000 to 15,000 cP, from 5,000 to 10,000 cP, from 10,000 to 20,000 cP, from 10,000 to 15,000 cP, from 15,000 to 20,000 cP, or any values within the foregoing ranges or any ranges created thereby, as measured at 0.2 s⁻¹.

The composition of the present disclosure may have a high shear viscosity at 100 s⁻¹ of from 100 to 1000 cP, from 100 to 800 cP, from 100 to 600 cP, from 100 to 400 cP, from 100 to 200 cP, from 200 to 1000 cP, from 200 to 800 cP, from 200 to 600 cP, from 200 to 400 cP, from 400 to 1000 cP, from 400 to 800 cP, from 400 to 600 cP, from 600 to 1000 cP, from 600 to 800 cP, from 800 to 1000 cP, or any values within the foregoing ranges or any ranges created thereby, as measured at 100 s⁻¹.

A ratio of the two (low shear viscosity divided by high shear viscosity) when under 20 may demonstrate that the product has an ideal non-Newtonian rheology profile that is both physically stable and flows easily for the consumer. The ratio may range from 1 to 20, from 1 to 15, from 1 to 10, from 1 to 7, from 1 to 5, from 1 to 3, from 1 to 2, from 2 to 20, from 2 to 15, from 2 to 10, from 2 to 7, from 2 to 5, from 2 to 3, from 3 to 20, from 3 to 15, from 3 to 10, from 3 to 7, from 3 to 5, from 5 to 20, from 5 to 15, from 5 to 10, from 5 to 7, from 7 to 20, from 7 to 15, from 7 to 10, from 10 to 20, from 10 to 15, from 15 to 20, or any values within the foregoing ranges or any ranges created thereby. A composition within the provided ratio will be viscous enough at rest that it is stable but will be thin enough when poured that it dissolves during the wash. When the ratio is greater than 20, the composition will not dissolve into the wash-it will be so viscous that the water will not dissolve the composition to form a wash liquor. For example, if a composition having a ratio greater than 20 were dumped directly into a washing machine drum, the composition would not dissolve and would stay predominantly in place during dispensing and throughout the duration of the wash. If the composition has a ratio of less than 1, then the composition would not be stable in place, and would exhibit phase separation and would not stay emulsified.

### Fibrous Water-Soluble Unit Dose Article

The composition may be in the form of a fibrous water-soluble product. A fibrous water soluble product can include one or more layers. These layers may be superposed upon one another. The layers may lay directly upon one another, have particles in between the layers, or combination thereof.

The fibrous water-soluble unit dose article may comprise of 50% or greater of bio-based materials, such as for example between 50% and 95% bio-based. Some of the individual components of the fibrous water-soluble unit dose article may be fully bio-based to create an article that has a total bio-based content of greater than 50%.

These fibrous water-soluble unit dose articles can be dissolved under various wash conditions, e.g., low temperature, low water and/or short wash cycles or cycles where consumers have been overloading the machine, especially with items having high water absorption capacities, while providing sufficient delivery of active agents for the intended effect on the target consumer substrates (with similar performance as today's liquid products).

The surface of the fibrous water-soluble unit dose article may comprise a printed area. The printed area may cover between about 10% and about 100% of the surface of the article. The area of print may comprise inks, pigments, dyes, bluing agents or mixtures thereof. The area of print may be opaque, translucent or transparent. The area of print may comprise a single color or multiple colors. The printed area may be on more than one side of the article and contain instructional text, graphics, etc., The surface of the water-soluble unit dose article may comprise an aversive agent, for example a bittering agent. Suitable bittering agents include, but are not limited to, naringin, sucrose octacetate, quinine hydrochloride, denatonium benzoate, or mixtures thereof. Any suitable level of aversive agent may be used. Suitable levels include, but are not limited to, 1 to 5000 ppm, or even 100 to 2500 ppm, or even 250 to 2000 ppm.

The fibrous water-soluble unit dose articles may exhibit a thickness of greater than 0.01 mm and/or greater than 0.05 mm and/or greater than 0.1 mm and/or to about 100 mm and/or to about 50 mm and/or to about 20 mm and/or to about 10 mm and/or to about 5 mm and/or to about 2 mm and/or to about 0.5 mm and/or to about 0.3 mm.

The fibrous water-soluble unit dose articles may have basis weights of from about 500 grams/m2 to about 5,000 grams/m2, or from about 1,000 grams/m2 to about 4,000 grams/m2, or from about 1,500 grams/m2 to about 3,500 grams/m2, or from about 2,000 grams/m2 to about 3,000 grams/m2, or any combination thereof.

The fibrous water-soluble unit dose article may exhibit different regions, such as different regions of basis weight, density, caliper, and/or wetting characteristics. The fibrous water-soluble unit dose article may be compressed at the point of edge sealing. The fibrous water-soluble unit dose article may comprise texture on one or more of its surfaces. A surface of the fibrous water-soluble unit dose article may comprise a pattern, such as a non-random, repeating pattern. The fibrous water-soluble unit dose article may comprise apertures. The fibrous water-soluble unit dose article may comprise a fibrous structure having discrete regions of fibrous elements that differ from other regions of fibrous elements in the structure. The fibrous water-soluble unit dose article may be used as is or it may be coated with one or more active agents.

The fibrous water-soluble unit dose article may comprise one or more plies. The fibrous water-soluble unit dose article may comprise at least two and/or at least three and/or at least four and/or at least five plies. The fibrous plies can be fibrous structures. Each ply may comprise one or more layers, for example one or more fibrous element layers, one or more particle layers, and/or one or more fibrous element/particle mixture layers. The layer(s) may be sealed. In particular, particle layers and fibrous element/particle mixture layers may be sealed, such that the particles do not leak out. The water-soluble unit dose articles may comprise multiple plies, where each ply comprises two layers, where one layer is a fibrous element layer and one layer is a fibrous element/particle mixture layer, and where the multiple plies are sealed (e.g., at the edges) together. Scaling may inhibit the leakage of particles as well as help the unit dose article maintain its original structure. However, upon addition of the water-soluble unit dose article to water, the unit dose article dissolves and releases the particles into the wash liquor.

The fibrous water-soluble unit dose may be in the form of any three-dimensional structure. The fibrous water-soluble unit dose article can be perforated. The article can also be cut or shaped into various sizes for different intended uses. For example, the water-soluble unit dose may be in the form of a square, a rounded square, a kite, a rectangle, a triangle, a circle, an ellipse, and mixtures thereof.

The fibrous water-soluble unit dose may comprise less than 10 ingredients. The water-soluble unit dose may comprise between 3 and 9 ingredients, such as, for example, 4 ingredients, 5 ingredients, 6 ingredients, 7 ingredients, or 8 ingredients.

The fibrous water-soluble unit dose articles disclosed herein comprise a water-soluble fibrous structure and one or more particles. The fibrous water-soluble fibrous structure may comprise a plurality of fibrous elements, for example a plurality of filaments. The one or more particles, for example one or more active agent-containing particles, may be distributed throughout the structure. The fibrous water-soluble unit dose article may comprise a plurality of two or more and/or three or more fibrous elements that are inter-entangled or otherwise associated with one another to form a fibrous structure and one or more particles, which may be distributed throughout the fibrous structure.

The fibrous water-soluble unit dose article may comprise a water-soluble fibrous structure. The water-soluble fibrous structure may comprise two or more different fibrous elements. Non-limiting examples of differences in the fibrous elements may be physical differences, such as differences in diameter, length, texture, shape, rigidness, elasticity, and the like; chemical differences, such as crosslinking level, solubility, melting point, Tg, active agent, filament-forming material, color, level of active agent, basis weight, level of filament-forming material, presence of any coating on fibrous element, biodegradable or not, hydrophobic or not, contact angle, and the like; differences in whether the fibrous element loses its physical structure when the fibrous element is exposed to conditions of intended use; differences in whether the fibrous element's morphology changes when the fibrous element is exposed to conditions of intended use; and differences in rate at which the fibrous element releases one or more of its active agents when the fibrous element is exposed to conditions of intended use. Two or more fibrous elements within the fibrous structure may comprise different active agents. This may be the case where the different active agents may be incompatible with one another, for example an anionic surfactant and a cationic polymer. When using different fibrous elements, the resulting structure may exhibit different wetting, imbibition, and solubility characteristics.

### Fibrous Structure

Fibrous structures comprise one or more fibrous elements. The fibrous elements can be associated with one another to form a structure. Fibrous structures can include particles within and or on the structure. Fibrous structures can be homogeneous, layered, unitary, zoned, or as otherwise desired, with different active agents defining the various aforesaid portions.

A fibrous structure can comprise one or more layers, the layers together forming a ply.

### Fibrous Elements

The fibrous elements may be water-soluble. The fibrous elements may comprise one or more filament-forming materials and/or one or more active agents, such as a surfactant described above. The one or more active agents may be releasable from the fibrous element, such as when the fibrous element and/or fibrous structure comprising the fibrous element is exposed to conditions of intended use.

The fibrous elements may be spun from a filament-forming composition, also referred to as fibrous element-forming compositions, via suitable spinning process operations, such as meltblowing, spunbonding, electro-spinning, and/or rotary spinning.

“Filament-forming composition” and/or “fibrous element-forming composition” as used herein means a composition that is suitable for making a fibrous element such as by meltblowing and/or spunbonding. The filament-forming composition comprises one or more filament-forming materials that exhibit properties that make them suitable for spinning into a fibrous element. The filament-forming material may comprise a polymer. In addition to one or more filament-forming materials, the filament-forming composition may comprise one or more active agents, for example, a surfactant. In addition, the filament-forming composition may comprise one or more polar solvents, such as water, into which one or more, for example all, of the filament-forming materials and/or one or more, for example all, of the active agents are dissolved and/or dispersed prior to spinning a fibrous element, such as a filament from the filament-forming composition.

The filament-forming composition may comprise two or more different filament-forming materials. Thus, the fibrous elements may be monocomponent (one type of filament-forming material) and/or multicomponent, such as bicomponent. The two or more different filament-forming materials may be randomly combined to form a fibrous element. The two or more different filament-forming materials may be orderly combined to form a fibrous element, such as a core and sheath bicomponent fibrous element, which is not considered a random mixture of different filament-forming materials for purposes of the present disclosure. Bicomponent fibrous elements may be in any form, such as side-by-side, core and sheath, islands-in-the-sea and the like.

The fibrous elements may each contain at least one filament-forming material. In addition, the fibrous element may contain one or more active agents. These active agents can be any of the materials mentioned above for inclusion in a detergent composition.

The fibrous element may comprise at least about 5%, and/or at least about 10%, and/or at least about 15%, and/or at least about 20%, and/or less than about 80%, and/or less than about 75%, and/or less than about 65%, and/or less than about 60%, and/or less than about 55%, and/or less than about 50%, and/or less than about 45%, and/or less than about 40%, and/or less than about 35%, and/or less than about 30%, and/or less than about 25% by weight on a dry fibrous element basis and/or dry fibrous structure basis of the filament-forming material and greater than about 20%, and/or at least about 35%, and/or at least about 40%, and/or at least about 45%, and/or at least about 50%, and/or at least about 55%, and/or at least about 60%, and/or at least about 65%, and/or at least about 70%, and/or less than about 95%, and/or less than about 90%, and/or less than about 85%, and/or less than about 80%, and/or less than about 75% by weight on a dry fibrous element basis and/or dry fibrous structure basis of an active agent, preferably surfactant. The fibrous element may comprise greater than about 80% by weight on a dry fibrous element basis and/or dry fibrous structure basis of surfactant.

Preferably, each fibrous element may be characterized by a sufficiently high total surfactant content, e.g., at least about 30%, or at least about 40%, or at least about 50%, or at least about 60%, or at least about 70%, by weight on a dry fibrous element basis and/or dry fibrous structure basis of the first surfactant.

The total level of filament-forming materials present in the fibrous element may be from about 5% to less than about 80% by weight on a dry fibrous element basis and/or dry fibrous structure basis and the total level of surfactant present in the fibrous element may be greater than about 20% to about 95% by weight on a dry fibrous element basis and/or dry fibrous structure basis.

In general, fibrous elements are elongated particulates having a length greatly exceeding average diameter, e.g., a length to average diameter ratio of at least about 10. A fibrous element may be a filament or a fiber. Filaments are relatively longer than fibers. A filament may have a length of greater than or equal to about 5.08 cm (2 in.), and/or greater than or equal to about 7.62 cm (3 in.), and/or greater than or equal to about 10.16 cm (4 in.), and/or greater than or equal to about 15.24 cm (6 in.). A fiber may have a length of less than about 5.08 cm (2 in.), and/or less than about 3.81 cm (1.5 in.), and/or less than about 2.54 cm (1 in.).

The one or more filament-forming materials and active agents may be present in the fibrous element at a weight ratio of total level of filament-forming materials to active agents of about 2.0 or less, and/or about 1.85 or less, and/or less than about 1.7, and/or less than about 1.6, and/or less than about 1.5, and/or less than about 1.3, and/or less than about 1.2, and/or less than about 1, and/or less than about 0.7, and/or less than about 0.5, and/or less than about 0.4, and/or less than about 0.3, and/or greater than about 0.1, and/or greater than about 0.15, and/or greater than about 0.2. The one or more filament-forming materials and active agents may be present in the fibrous element at a weight ratio of total level of filament-forming materials to active agents of about 0.2 to about 0.7.

The fibrous element may comprise from about 10% to less than about 80% by weight on a dry fibrous element basis and/or dry fibrous structure basis of a filament-forming material, such as polyvinyl alcohol polymer, starch polymer, and/or carboxymethylcellulose polymer, and greater than about 20% to about 90% by weight on a dry fibrous element basis and/or dry fibrous structure basis of an active agent, such as surfactant. The fibrous element may further comprise a plasticizer, such as glycerin, and/or additional pH adjusting agents, such as citric acid. The fibrous element may have a weight ratio of filament-forming material to active agent of about 2.0 or less. The filament-forming material may be selected from the group consisting of polyvinyl alcohol, starch, carboxymethylcellulose, polyethylene oxide, and other suitable polymers, especially hydroxyl-containing polymers and their derivatives. The filament-forming material may range in weight average molecular weight from about 100,000 g/mol to about 3,000,000 g/mol. It is believed that in this range, the filament-forming material may provide extensional rheology, without being so clastic that fiber attenuation is inhibited in the fiber-making process.

The one or more active agents may be releasable and/or released when the fibrous element and/or fibrous structure comprising the fibrous element is exposed to conditions of intended use. The one or more active agents in the fibrous element may be selected from the group consisting of surfactants, organic polymeric compounds, and mixtures thereof.

The fibrous elements may exhibit a diameter of less than about 300 μm, and/or less than about 75 μm, and/or less than about 50 μm, and/or less than about 25 μm, and/or less than about 10 μm, and/or less than about 5 μm, and/or less than about 1 μm. The fibrous elements may exhibit a diameter of greater than about 1 μm as measured according to the Diameter Test Method described herein. The diameter of a fibrous element may be used to control the rate of release of one or more active agents present in the fibrous element and/or the rate of loss and/or altering of the fibrous element's physical structure.

The active agents in a fibrous water-soluble product may also be in the form of particles. Particles may be incorporated into a fibrous water-soluble product at a level of about 0.1 g to about 70 g. The type of particles utilized can be any that are compatible with the manufacturing system.

The particles may be a powder, granule, agglomerate, encapsulate, microcapsule, and/or prill. The particles may be made using a number of well-known methods in the art, such as spray-drying, agglomeration, extrusion, prilling, encapsulation, pastillation, and combinations thereof. The shape of the particles can be in the form of spheres, rods, plates, tubes, squares, rectangles, discs, stars, fibers or have regular or irregular random forms. The particles may have a D50 particle size of from about 100 μm to about 1600 μm.

The particles may include a mixture of chemically different actives, such as: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as colored noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, these enzyme granulates may comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

### Packaging for the Compositions

The detergent compositions described herein can be packaged in any suitable container including those constructed from paper, cardboard, plastic materials, and any suitable laminates. The detergent compositions described herein may also be packaged as a multi-compartment detergent composition. The present disclosure also relates to a transparent or translucent liquid laundry detergent composition in a transparent bottle where the transparent or translucent composition has about 50% transmittance or greater of light using 1 cm cuvette at wavelength of 410-800 nanometers; and where the transparent bottle has light transmittance of greater than 25% at wavelength of about 410-800 nm.

Clear bottle materials that may be used include, but are not limited to: polypropylene (PP), polyethylene (PE), polycarbonate (PC), polyamides (PA) and/or polyethylene terephthalate (PETE), polyvinylchloride (PVC); and polystyrene (PS).

The transparent bottle or container may have a transmittance of more than about 25%, or more than about 30%, or more than about 40%, or more than about 50% in the visible part of the spectrum (approx. 410-800 nm). Alternatively, absorbency of the bottle may be measured as less than about 0.6 or by having transmittance greater than about 25%, where % transmittance equals:

$$\frac{1}{{10}^{absorbancy}} \times 100 \%$$

### Methods

### (A) pH Measurement:

The pH is measured, at 20° C., using a Santarius PT-10P PH meter with gel-filled probe (such as the Toledo probe, part number 52 000 100), calibrated according to the instruction manual. The pH is measured in a 10 wt % dilution in demineralised water (i.e. 1 part laundry detergent composition and 9 parts demineralised water).

### (B) Rheology Measurement:

The rheology is measured using an AR 2000 rheometer from TA instruments using a cone and plate geometry with a 40 mm diameter and an angle of 1°. The viscosity at the different shear rates is measured via a logarithmic shear rate sweep from 0.1 to 1200 s⁻¹ in 3 minutes time at 20° C. Low shear viscosity is measured at a continuous shear rate of 0.2 s⁻¹.

Of the shear sweep, the low shear viscosity at 0.2 s⁻¹ measurement represents the apparent viscosity when the composition is static, which correlates to product appearance to consumers as well as overall physical stability of the surfactant microstructure.

The high shear viscosity, at 100 s⁻¹ represents the liquid behavior in industrial processing as well as consumer use. Without intending to be bound by theory, it is believed that consumers tend to prefer a product with a high shear viscosity at 100 s⁻¹ of under 1000 cP for ease of use.

### (C) Enzyme Stability Measurement.

Prepare a diluent solution of 0.5 g calcium chloride dihydrate (Sigma-Aldrich, cat. #C-5080) and 10 g sodium thiosulfate pentahydrate (Sigma-Aldrich, cat. #S-6672) in 1 liter of deionized water (18.2 mega Ohms MΩ or better). Prepare a TRIS buffer of 12.1 g tris-hydroxymethyl-aminomethane (Sigma-Aldrich, cat. #-1503), 1.1 g of calcium chloride dihydrate and 5.0 g sodium thiosulfate pentahydrate, pH 8.3 in 1 liter of deionized water. Prepare a working PNA solution by diluting 250 μL of a 1 gram of N-Succinyl-ALA-ALA-PRO-PHE p-nitroanilide (“PNA”; Sigma-Aldrich, cat. #S-7388) per 10 mL dimethyl sulfoxide (J. T. Baker, cat. #JT9224-1) into 25 mL TRIS buffer.

C-1 Protease analysis: Protease analysis is carried out by reaction of a protease containing sample with Succinyl-Ala-Ala-Pro-Phe p-nitroanilide resulting in a change in absorbance over time spectrophotometrically. The response is proportional to the level of protease present in the sample. The protease sample is prepared by dilution in diluent solution. The reaction begins by incubation of 200 μL of working PNA solution at 37° C. for 360 seconds then delivery of 80 uL sample preparation and monitoring change in absorbance at 405 nm. The protease active level is determined by relation to a protease level vs. reaction rate calibration established for that specific protease. For example, a reference curve may be established by measuring post-reaction absorbance as described above over a range of known enzyme concentrations, for example, from about 1 mg enzyme/100 g product to about 100 mg enzyme/100 g product. “RA Protease” is used to define the percent retained enzyme activity, it's the measured value of the protease after aging. As shown in the Examples below, it is after 2 weeks at 35° C. Without intending to be bound by theory, this is comparable to approximately 1 year of shelf-life of the composition at room temperature.

C-2 Amylase analysis: The amylase reaction uses a combination of the alpha amylase present in the sample and an alpha glucosidase to react with a modified p-nitrophenylmaltoheptaside containing a terminal glucose unit blocked with an ethylidene group. This terminal blocking inhibits cleavage by the alpha-glucosidase until the initial internal bonds can be cleaved by the alpha-amylase followed by alpha-glucosidase. The increase in absorbance (@ 405 nm) per minute, facilitated by the release of pNP by the alpha-glucosidase, is directly proportional to the alpha-amylase activity in the sample. The amylase sample is prepared by dilution in diluent solution. The reaction reagents are provided in Alpha amylase reagent (Thermo Fisher, cat. #984373). The reaction begins by incubation of 190 μL of Alpha amylase reagent at 37° C. for 390 seconds then delivery of 25 μL of the diluted sample preparation and monitoring the change in absorbance at 405 nm spectrophotometrically. The amylase active level is determined by relation to an amylase level vs. reaction rate calibration established for that specific amylase. For example, a reference curve may be established by measuring post-reaction absorbance as described above over a range of known enzyme concentrations, for example, from about 1 mg enzyme/100 g product to about 100 mg enzyme/100 g product. “RA Amylase” is used to define the percent retained enzyme activity, it's the measured value of the amylase after aging. As shown in the Examples below, it is after 2 weeks at 35° C. Without intending to be bound by theory, this is comparable to approximately 1 year of shelf-life of the composition at room temperature.

### Examples

TABLE 1
Heavy Duty Liquid Example Compositions

| | Comp. 1 | Comp. 2 | Comp. 3 | Comp. 4 | Comp. 5 | Comp. 6 | Comp 7 |
|---|---|---|---|---|---|---|---|
| Raw Material | % wt | % wt | % wt | % wt | % wt | % wt | % wt |
| Branched Alkyl | 0 | 0 | 15 | — | — | — | 0 |
| Sulfate¹² (BAS) | | | | | | | |
| Sodium Lauryl | — | 0 | 0 | 3.0 | 4.2 | 5.0 | 0 |
| Sulfate¹⁸ | | | | | | | |
| linear alkyl benzene | 4.3 | 7 | 4 | 3.0 | 12.9 | 8.3 | 12 |
| sulfonate | | | | | | | |
| AE3S Ethoxylated | 0 | 1.4 | 0 | — | — | — | 2.3 |
| alkyl sulfate with | | | | | | | |
| an average degree | | | | | | | |
| of ethoxylation of 3 | | | | | | | |
| C25AES | 1.36 | 0 | 2 | — | 2.5 | 0.9 | 0 |
| Ethoxylated alkyl | | | | | | | |
| sulfate with an | | | | | | | |
| average degree of | | | | | | | |
| ethoxylation of 2.5¹ | | | | | | | |
| C12-14 | 0.17 | 0.5 | 1.3 | 1.3 | 0.9 | 1.0 | 0 |
| dimethylamine | | | | | | | |
| oxide⁵ | | | | | | | |
| Nonionic | 5.1 | 12.9 | 5.3 | 15 | 14.5 | 14 | 4.8 |
| Surfactant² | | | | | | | |
| citric acid | 0.24 | 0.12 | 3.4 | 1.2 | 0.8 | 0.26 | 2.7 |
| Sodium citrate | 0 | 0.64 | 0 | 0 | 0 | 0 | 0 |
| fatty acid | 0 | 2.4 | 2.9 | 1.6 | 0.5 | 0.15 | 2.1 |
| Mannanase | 0.0017 | 0.0017 | 0.0017 | 0.0017 | 0.0017 | 0.0017 | 0.0017 |
| Pectawash | 0.00343 | 0.0343 | 0.00342 | 0.00343 | 0.00343 | 0.00343 | 0.00343 |
| Amylase | 0.00766 | 0.0076 | 0.00766 | 0.00766 | 0.00766 | 0.00766 | 0.00766 |
| Protease | 0.007706 | 0.00706 | 0.07706 | 0.07706 | 0.07706 | 0.07706 | 0.07706 |
| calcium/sodium | 0 | 0 | 0.08 | 0.06 | 0 | 0.3 | 0 |
| formate | | | | | | | |
| Sodium/Calcium | 1.5 | 0.3 | 0.03 | 0 | 0.12 | 0 | 0.02 |
| Chloride | | | | | | | |
| Ethoxylated | 0.5 | 1.1 | 2.7 | 1.1 | 1.6 | 0.3 | 0 |
| polyethyleneimine⁴ | | | | | | | |
| Amphiphilic graft | 0 | 0 | 0 | 0 | 0 | 0 | 0.97 |
| copolymer | | | | | | | |
| Ethoxylated- | 0.8 | 0.8 | 1.1 | 1.5 | 1.9 | 1.0 | 0 |
| Propoxylated | | | | | | | |
| polyethyleneimine | | | | | | | |
| Zwitterionic | 0 | 0 | 0 | 0 | 0 | 0 | 0.55 |
| polyamine | | | | | | | |
| VAP⁵ | 0.3 | 0.2 | 0.2 | 0 | 0 | 0.4 | 0.3 |
| DTPA chelant¹³ | 0.0 | 0.3 | 0.0 | 0.0 | 0.0 | 0.0 | 0.0 |
| GLDA chelant¹⁴ | 0.12 | 0 | 0.23 | 0.3 | 0.3 | 0.21 | 0 |
| DTPMP | 0 | 0 | 0 | 0 | 0 | 0 | 0.81 |
| Fluorescent | 0 | 0.04 | 0.05 | 0 | 0.1 | 0.2 | 0.05 |
| Brightener⁶ | | | | | | | |
| Ethanol | 0.2 | 0 | 2.1 | 0.92 | 2.3 | 2.7 | 0.61 |
| propylene glycol | 1.3 | 0.33 | 6.7 | 1.4 | 0.87 | 0.7 | 1.1 |
| Glycerine | 0 | 0 | 0 | 0 | 0 | 0 | 0.1 |
| monoethanolamine | 1.1 | 0 | 0.6 | 0 | 3.35 | 1.93 | 0.21 |
| DETA¹⁵ | 0 | 0 | 0.05 | 0 | 0.06 | 0.05 | 0 |
| Antioxidant⁷ | 0 | 0 | 0.1 | 0 | 0.05 | 0.05 | 0 |
| Hygiene Agent⁸ | 0 | 0.04 | 0 | 0 | 0 | 0 | 0 |
| NaOH | 0.2 | 0 | 1.1 | 1.3 | 0.13 | 0 | 3.5 |
| NaCS | 0.09 | 0 | 0.15 | 0.53 | 0.3 | 0.6 | 1.87 |
| Hydrogenated | 0.08 | 0.12 | 0.12 | 0 | 0.08 | 0 | 0.26 |
| Castor Oil | | | | | | | |
| aesthetic dye | 0.02 | 0.006 | 0.017 | 0 | 0.01 | 0.01 | |
| Leuco dye¹⁶ | 0 | 0 | 0 | 0 | 0 | 0 | 0.03 |
| Perfume | 0.4 | 0.5 | 0.6 | 0 | 0.8 | 0.7 | 1.39 |
| Perfume | 0.5 | 0 | 0.1 | 0 | 0.3 | 0 | 0 |
| microcapsules | | | | | | | |
| silicone antifoam⁹ | 0 | 0.03 | 0 | 0 | 0.1 | 0.01 | 0.03 |
| Hueing dye¹⁰ | 0 | 0 | 0 | 0 | 0.3 | 0.25 | 0 |
| Sodium sulfate | 0 | 0.15 | 0 | 0 | 0 | 0 | 0.06 |
| preservative | 0.03 | 0.0003 | 0 | 0.01 | 0 | 0.01 | 0 |
| water & | balance | balance | balance | balance | balance | balance | balance |
| miscellaneous | | | | | | | |

¹C12-15EO2.5S Alkyl ethoxy sulfate where the alkyl portion of AES includes from about 13.9 to 14.6 carbon atoms
²Surfonic L24-9 commercially available from Huntsman and/or Neodol 45-7 commercially available from Shell Chemicals
³Nuclease enzyme is as claimed in co-pending European application 19219568.3
⁴PE-20 commercially available from BASF
⁵VAP is a graft polymer comprising a polyalkylene oxide back-bone and side chains derived from N-vinylpyrrolidone (B), and side chains derived from vinyl ester (C) derived from a saturated monocarboxylic acid containing from 1 to 6 carbon atoms and/or a methyl or ethyl ester of acrylic or methacrylic acid as described in WO2020005476.
⁶Fluorescent Brightener is disodium 4,4′-bis{[4-anilino-6-morpholino-s-triazin-2-yl]-amino}-2,2′-stilbenedisulfonate or 2,2′-([1,1′-Biphenyl]-4,4′-diyldi-2,1-ethenediyl)bis-benzenesulfonic acid disodium salt.
⁷Antioxidant 1 is 3,5-bis(1,1-dimethylethyl)-4-hydroxybenzenepropanoic acid, methyl ester [6386-38-5]
⁸Hygiene Agent is agent is Tinosan HP 100 commercially available from BASF
⁹Silicone emulsion is Xiameter AFE-0110 or AF8017 supplied by Dow Corning
¹⁰Polymeric dyes such as described in WO2011/98355, U.S. 2012/225803 A1, U.S. 2012/090102 A1, U.S. 7,686,892 B2, and WO2010/142503, WO2011/045195, WO2010/148624, WO2010/102861, WO2011/098355, WO2012/163871, WO2012/26665, WO2012/119859 and WO2011/047987
¹¹Preservative is Benzisothiazolinone (BIT) and/or Methylisothiazolinone (MIT)
¹²BAS is a Branched 2-alkyl primary alkyl alcohol sulfate as described in U.S. 1,180,782
¹³DTPA is Diethylenetriaminepentaacetic acid
¹⁴GLDA is Glutamic acid diacetic acid
¹⁵DETA is Diethylenetriamine
¹⁶Leuco dyes as disclosed in U.S. 10/676,699 and U.S. 10/717,950
¹⁷DTPMP chelant is diethylene triamine penta(methyl phosphonic) acid
¹⁸SLS is STEPANOL ® WA-EXTRA-HP, supplied by Stepan Company

TABLE 2
Examples in accordance with the present disclosure

| | Example | Example | Example | Example | Comparative | Example |
|---|---|---|---|---|---|---|
| | A | B | C | D | Example E | F |
| | wt. % | wt. % | wt. % | wt. % | wt. % | wt. % |
| Surfactant system: | | | | | | |
| Sodium lauryl | 9% | 9% | 0% | 0% | 10% | 8% |
| sulfate⁶ (SLS) | | | | | | |
| Branched alkyl | 0% | 0% | 9% | 9% | 0% | 0% |
| sulfate C15¹ (BAS) | | | | | | |
| Alcohol ethoxylate | 9% | 9% | 9% | 9% | 0% | 4% |
| C12-C14 9EO (24- | | | | | | |
| 9 AE)² | | | | | | |
| Linear alkyl | 0% | 0% | 0% | 0% | 10% | 0% |
| benzene sulfonate³ | | | | | | |
| (LAS) | | | | | | |
| C12-14 Di methyl | 0% | 0% | 0% | 0% | 0% | 0% |
| Amine oxide (AO)⁵ | | | | | | |
| Alkyl ether sulfate | 0% | 0% | 0% | 0% | 0% | 0% |
| (AES)⁷ | | | | | | |
| Surfactant system | 18% | 18% | 18% | 18% | 20% | 12% |
| Citric Acid | 3.0% | 3.0% | 3.0% | 3.0% | 1.0% | 1.0% |
| GLDA⁴ | 1.0% | 1.0% | 1.0% | 1.0% | 0.5% | 0.5% |
| Protease | 0.10% | 0.10% | 0.10% | 0.10% | 0.05% | 0.05% |
| Amylase | 0.04% | 0.04% | 0.04% | 0.04% | 0.02% | 0.02% |
| Sodium Formate | 0.00% | 0.00% | 0.00% | 0.00% | 0.00% | 0.00% |
| Calcium Formate | 0.19% | 0.19% | 0.19% | 0.19% | 0.02% | 0.02% |
| 10% pH | 6.2 | 8.2 | 6.2 | 8.2 | 6.0 | 6.0 |
| 2 week, 35° C. data | | | | | | |
| RA Protease | 88% | 72% | 88% | 73% | 0% | 51% |
| RA Amylase | 100% | 97% | 93% | 98% | 0% | 24% |

TABLE 3
Examples in accordance with the present disclosure

| | Comparative | | Comparative | | Comparative |
|---|---|---|---|---|---|
| | Example G | Example H | Example I | Example J | Example K |
| | wt. % | wt. % | wt. % | wt. % | wt. % |
| Surfactant system: | | | | | |
| Sodium lauryl sulfate⁶ | 8% | 6% | 6% | 0% | 8% |
| (SLS) | | | | | |
| Branched alkyl sulfate | 0% | 0% | 0% | 0% | 0% |
| C15¹ (BAS) | | | | | |
| Alcohol ethoxylate | 0% | 6% | 0% | 6% | 2% |
| C12-C14 9EO² (24-9 | | | | | |
| AE) | | | | | |
| Linear alkyl benzene | 4% | 0% | 6% | 6% | 2% |
| sulfonate³ (LAS) | | | | | |
| C12-14 dimethyl | 0% | 0% | 0% | 0% | 0% |
| Amine oxide (AO)⁵ | | | | | |
| Alkyl ether sulfate | 0% | 0% | 0% | 0% | 0% |
| (AES)⁷ | | | | | |
| Surfactant system | 12% | 12% | 12% | 12% | 12% |
| Citric Acid | 1.0% | 1.0% | 1.0% | 1.0% | 1.0% |
| GLDA⁴ | 0.5% | 0.5% | 0.5% | 0.5% | 0.5% |
| Protease | 0.05% | 0.05% | 0.05% | 0.05% | 0.05% |
| Amylase | 0.02% | 0.02% | 0.02% | 0.02% | 0.02% |
| Sodium Formate | 0.00% | 0.00% | 0.00% | 0.00% | 0.00% |
| Calcium Formate | 0.02% | 0.02% | 0.02% | 0.02% | 0.02% |
| 10% pH | 6.0 | 6.0 | 6.0 | 6.0 | 6.0 |
| 2 week, 35° C. data | | | | | |
| RA Protease | 0% | 96% | 0% | 85% | 0% |
| RA Amylase | 51% | 47% | 55% | 44% | 20% |

TABLE 4
Examples in accordance with the present disclosure

| | Exam- | Exam- | Exam- | Exam- |
|---|---|---|---|---|
| | ple L | ple M | ple N | ple O |
| | wt. % | wt. % | wt. % | wt. % |
| Surfactant system: | | | | |
| Sodium lauryl sulfate⁶ | 0% | 0% | 4% | 0% |
| (SLS) | | | | |
| Branched alkyl sulfate¹ C15 | 3% | 3% | 0% | 0% |
| (BAS) | | | | |
| Alcohol ethoxylate C12- | 14% | 14% | 18% | 6.50% |
| C14 9EO² (24-9 AE) | | | | |
| Linear alkyl benzene | 3% | 3% | 4% | 3.45% |
| sulfonate³ (LAS) | | | | |
| C12-14 dimethylamine | 0% | 0% | 2% | 0.30% |
| oxide (AO)⁵ | | | | |
| Alkyl ether sulfate (AES)⁷ | 0% | 0% | 0% | 1.35% |
| Surfactant system | 20% | 20% | 27% | 12% |
| Citric Acid | 1.0% | 1.0% | 1.5% | 0.75% |
| GLDA⁴ | 0.3% | 0.3% | 0.3% | 0.07% |
| Protease | 0.16% | 0.16% | 0.08% | 0.04% |
| Amylase | 0.01% | 0.01% | 0.02% | 0.01% |
| Sodium Formate | 0.50% | 0.50% | 0.00% | 0% |
| Calcium Formate | 0.03% | 0.03% | 0.04% | 0.01% |
| 10% pH | 5.9 | 6.6 | 6.5 | 6.1 |
| 2 week, 35° C. data | | | | |
| RA Protease | 98% | 99% | 96% | 71% |
| RA Amylase | 78% | 97% | 84% | 73% |

¹BAS is a highly branched, 2-alkyl primary alkyl alcohol sulfate as described in U.S. Pat. No. 1,180,782
²C12-C14 nonionic ethoxylate with an average degree of ethoxylation equal to 9, available as Surfonic ® L24-9 from Indorama Ventures
³CALSOFT ® LAS-99, supplied by Pilot Chemical Company
⁴GLDA is glutamate diacetate available from Nouryon as Dissolvine ® GL-47S
⁵Amine Oxide is Libranox ® AO 12/14 from Libra Specialty Chemicals LTD
⁶Sodium lauryl sulfate (SLS) is STEPANOL ® WA-EXTRA-HP, supplied by Stepan Company
⁷AES is C12-15EO2.5S Alkyl ethoxy sulfate where the alkyl portion of AES has a molecular weight of 211 to 218 Daltons, available from P&G Chemicals

Comparative Examples E, G, I, and K have nonionic levels of less than 30 wt. % nonionic surfactant by weight of the surfactant system.

Example A has 18 wt. % surfactant system by weight of the composition, where the surfactant system includes SLS, an alkyl sulfate anionic surfactant and 24-9 nonionic surfactant (alcohol ethoxylate). Example A shows strong retained enzyme activity of 88% RA Protease and 100% RA Amylase when the nonionic surfactant is roughly 50% of the surfactant composition and at pH 6.2.

Example B has the same composition as Example A, but Example B has a pH of 8.2 (compared to Example A at 6.2 pH). Example B exhibits lower RA Protease (72%) and lower RA Amaylase (97%) than Example A. The pH was modified by trimming the composition with sodium hydroxide.

Example C replaces the SLS of Example A with BAS. Example B shows retained enzyme activity with a 50:50 alkyl sulfate to nonionic surfactant system is not specific to chain length (SLS is a C24 surfactant, whereas the BAS is C15) nor branching (SLS is 100% linear, BAS is 86% branched), as the results of a C15 BAS is capable of providing comparably strong retained activity results as Example A. Example C shows 88% RA Protease and 93% RA Amylase.

Example D has the same composition as Example C, but Example D has a pH of 8.2. Similarly to the comparison between Examples A and B, when a highly branched AS chassis (Example C) is pH′ed to 8.2, we see similar reductions in protease retained activity. Example D shows 73% RA Protease and 98% RA Amylase. The pH was modified by trimming the composition with sodium hydroxide.

Comparative Example E starts to dimension the impact of a completely anionic based surfactant chassis. When no nonionic surfactant is formulated in the surfactant composition, at pH 6, no enzyme activity can be found in the chassis. Comparative Example E shows 0% RA Protease and 0% RA Amylase.

Example F is demonstrative of a low surfactant system where the composition includes 33 wt. % nonionic surfactant by weight of the surfactant system. Example F shows 51% RA Protease and 24% RA Amylase, which exhibits some retained activity in the composition at pH 6, but starts to show that enzyme activity starts to decrease as the presence of nonionic surfactant decreases.

Comparative Example G replaces the nonionic surfactant of Example F with LAS anionic surfactant, demonstrating the criticality of the presence of nonionic surfactant within the surfactant system. Comparative Example G shows 0% RA Protease and 51% RA Amylase.

Example H demonstrates the increase in enzyme RA when the composition is formulated with 50 wt. % nonionic surfactant by weight of the surfactant system and at pH 6, however this example is at a lower total surfactant (12 wt. %) present in the composition, different from examples A-D. Example H shows 96% RA Protease and 47% RA Amylase.

Comparative Example I, with a total surfactant level of 12 wt. % by weight of the composition, whereby the surfactant system is 100 wt. % anionic surfactant (SLS and LAS) shows that total surfactant level being lower does not improve the enzyme RA as Comparative Example I shows 0% RA Protease and 55% RA Amylase. This is also observed with Comparative Example E at 20 wt. % total surfactant by weight of the composition.

Example J shows a further nonlimiting example that LAS alone does not take enzyme RA to 0%, such as when it is formulated in a surfactant composition whereby 50 wt. % of the surfactant system is LAS anionic and the other 50 wt. % is nonionic surfactant. Here we significantly improved enzyme RA (85% protease) even when LAS is formulated, but when NI is greater than 30 wt. % of the surfactant system—in this case, 50 wt. %. Example J shows 85% RA Protease and 44% RA Amylase.

Comparative Example K includes less than 30 wt. % nonionic surfactant (16.7 wt. %) by weight of the surfactant system at pH 6. Comparative Example K shows 0% RA Protease and 20% RA Amylase.

Example L shows a ternary surfactant system comprised of multiple anionics, where the composition includes 20 wt. % surfactant system by weight of the composition, where 70% nonionic surfactant can be formulated alongside LAS anionic as a ternary surfactant and excellent enzyme RA results are achieved, demonstrating that the presence of LAS anionic in a composition having 20 wt. % surfactant system by weight of the composition can achieve strong RA results at pH 6. Example L shows 98% RA Protease and 78% RA Amylase.

Example M has the same composition as Example L, but has a pH of 6.6. Example M shows 99% RA Protease and 97% RA Amylase.

Example N has 27 wt. % surfactant system by weight of the composition and has a 4 surfactant system, adding amine oxide, demonstrating that amine oxide does not negatively impact the enzyme RA. Example N shows 96% RA Protease and 84% RA Amylase.

Example O has 12 wt. % surfactant system by weight of the composition and has a 4 surfactant system. Example O also has greater than 50 wt. % nonionic by weight of the surfactant system and has a pH of 6. Example O shows 71% RA Protease and 73% RA Amylase.

The Examples show a high correlation between enzyme stability and nonionic surfactant being present at greater than 30 wt. % by weight of the surfactant system. This trend is present across the broad range of surfactant levels.

Comparative Examples E, G, and I demonstrate that when no nonionic surfactant is present, protease enzymes are completely degraded. Example F demonstrates that when nonionic makes up one third of the surfactant system by weight of the surfactant system, protease stability substantially improves. All examples in which nonionic surfactant makes up at least 50 wt. % of the total surfactant system by weight of the surfactant system exhibit good enzyme stability across both protease and amylase.

What is claimed is:

1. A detergent composition comprising:
from 1 to 50 wt. % of a surfactant system by weight of the composition, wherein the surfactant system comprises:
greater than 30 wt. % nonionic surfactant by weight of the surfactant system,
less than 30 wt. % linear alkyl benzene sulfonate surfactant by weight of the surfactant system, and
a surfactant selected from the group consisting of sodium lauryl sulfate, highly branched alkyl sulfate, amine oxide, alkyl glycol sulfate, or combinations thereof; and
at least 0.5 wt. % (organic acid by weight of the composition;
wherein:
the composition comprises less than 8 wt. % alcohol ethoxy sulfate surfactant by weight of the composition;
the composition is substantially free of elemental boron complexes, and
the composition has a pH of from 5.4 to 6.7.

2. The detergent composition of claim 1, wherein the surfactant comprises alkyl glycol sulfate and the alkyl glycol sulfate comprises alkyl ethylene glycol sulfate.

3. The detergent composition of claim 1, wherein the organic acid is selected from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, fumaric acid, aspartic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof.

4. The detergent composition of claim 1, wherein the organic acid selected from the group consisting of acetic acid, lactic acid, and citric acid.

5. The detergent composition of claim 1, the surfactant system is substantially free of alcohol ethoxy sulfate surfactant.

6. The detergent composition of claim 1, wherein the composition comprises from 8 to 40 wt. % of a surfactant system by weight of the composition.

7. The detergent composition of claim 1, wherein the composition comprises from 0.01 to 2 wt. % of a chelating agent, by weight of the composition.

8. The detergent composition of claim 1, wherein the surfactant system comprises greater than 50 wt. % nonionic surfactant by weight of the surfactant system.

9. The detergent composition of claim 1, wherein the composition has a pH of from 5.7 to 6.3.

10. The detergent composition of claim 1, wherein elemental boron complexes are chosen from the group consisting of sodium tetraborate, boronic acids, sodium metaborate, perborate, and combinations thereof.

11. The detergent composition of claim 1, further comprising one or more detersive enzymes selected from protease, amylase, mannanase, xyloglucanase, pectate lyase, cellulase, and combinations thereof.

12. The detergent composition of claim 1, the composition has a viscosity of from 100 and 1000 cP as measured at a shear rate of 100 s⁻¹.

13. The detergent composition of claim 1, the composition has a viscosity ratio of less than 10.

14. The detergent composition of claim 1, wherein the composition comprises less than 15 wt. % alcohol ethoxy sulfate surfactant by weight of the surfactant system.

15. A method for treating a stain on a fabric, comprising:
washing the fabric in a wash liquor comprising a detergent composition comprising:
from 1 to 50 wt. % of a surfactant system by weight of the composition, wherein the surfactant system comprises:
greater than 30 wt. % nonionic surfactant by weight of the surfactant system,
less than 30 wt. % linear alkyl benzene sulfonate surfactant by weight of the surfactant system, and
a surfactant selected from the group consisting of sodium lauryl sulfate, highly branched alkyl sulfate, amine oxide, alkyl glycol sulfate, or combinations thereof; and
at least 0.5 wt. % organic acid by weight of the composition;
wherein:
the composition comprises less than 15 wt. % alcohol ethoxy sulfate surfactant by weight of the surfactant system;
the composition is substantially free of elemental boron complexes, and
the composition has a pH of from 5.4 to 6.7.

16. The method of claim 15, wherein the stain comprises beverage, fruit, vegetable, or a combination thereof.

17. The method of claim 15, wherein the detergent composition is in the form of a liquid, gel, powder, bead, granule, fiber, or any combination thereof.

18. A detergent composition comprising:
from 1 to 50 wt. % of a surfactant system by weight of the composition, wherein the surfactant system comprises:
greater than 30 wt. % nonionic surfactant by weight of the surfactant system,
less than 30 wt. % linear alkyl benzene sulfonate surfactant by weight of the surfactant system, and
a surfactant selected from the group consisting of sodium lauryl sulfate, highly branched alkyl sulfate, amine oxide, alkyl glycol sulfate, or combinations thereof; and
at least 0.5 wt. % organic acid by weight of the composition;
wherein:
the composition is substantially free of elemental boron complexes, and
the composition has a pH of from 5.4 to 6.7.

19. The detergent composition of claim 18, wherein the organic acid selected from the group consisting of acetic acid, lactic acid, citric acid, maleic acid, and fumaric acid.

20. The detergent composition of claim 18, wherein the composition is substantially free of brightener.
